(19) United States
(12) Patent Application Publication
(10) Pub. No.: US 2026/0239257 A1
(43) Pub. Date: Aug. 13, 2026

(54) CROSS-DOMAIN TRUST COLLABORATION IN WIRELESS COMMUNICATION

(71) Applicant: InterDigital Patent Holdings, Inc., Wilmington, DE (US)

(72) Inventors: Liangkun Yu, Conshohocken, PA (US); Chonggang Wang, Princeton, NJ (US); Robert Gazda, Spring City, PA (US); Xu Li, Plainsboro, NJ (US); Samir Ferdi, Kirkland (CA); Ulises Olvera-Hernandez, Saint-Lazare (CA); Rocco Di Girolamo, Laval (CA); Michael Starsinic, Newtown, PA (US); Michel Roy, Candiac (CA); Catalina Mladin, Hatboro, PA (US)

(73) Assignee: InterDigital Patent Holdings, Inc., Wilmington, DE (US)

(21) Appl. No.: 19/049,683

(22) Filed: Feb. 10, 2025

(51) Int. Cl. H04W 60/00; H04W 12/108; H04W 84/12

(52) U.S. Cl. CPC H04W 60/00; H04W 12/108; H04W 84/12

(57) ABSTRACT

A function entity (FE) receives an FE trust registration request notification from a network node, including contact information of the network node. The FE sends an FE trust registration request to the network node, including contact information of external trust management functions (eTMFs), and an identifier of the FE. The FE receives an FE trust registration response from the network node, including one or more of: an identifier of an FE profile for the FE, an identifier of the eTMFs, an identifier of eTMF profiles, an association of the FE profile and the eTMF profiles, or an identifier of the network node. The FE sends an FE trust registration completion notification to a selected eTMF of the eTMFs, based on the FE trust registration response. The FE trust registration completion notification includes the identifier of the network node, an identifier of the selected eTMF, and the identifier of the FE.

### BACKGROUND

Fifth Generation (5G) system architecture consists of a User Equipment (UE) or wireless transmit/receive unit (WTRU), Radio Access Network (RAN), and Core Network (CN). One of the design principles for the 5G System (5GS) is service-centric or service-based. The 5G Core Network (5GC) follows Service-Based Architecture (SBA) and contains a variety of Network Functions (NFs), which work together to fulfill and provide needed services to the RAN, WTRUs, and Application Servers/Service Providers. WTRU interacts with the RAN/5GC via Non-Access Stratum (NAS) and Access Stratum (AS) signaling.

A NF can access other network functions in request/response mode or subscription/notification mode. Before two NFs interact with each other, they first need to register with a Network Repository Function (NRF) so that they can discover each other via the NRF. Among these network functions, an Access and Mobility Management Function (AMF) is dedicated to managing a WTRU's access to the 5GS and its mobility, a Session Management Function (SMF) is responsible for establishing sessions between a WTRU and the 5GC, and an Authentication Server Function (AUSF) takes charge of WTRU authentication. In addition, a Policy Control Function (PCF) provides policy rules for other control plane network functions and WTRUs. Further, the PCF assigns an identifier for each created policy rule, which other control plane network functions and WTRUs use to refer to the corresponding policy rule. A User Plane Function (UPF) is the only core network function in the data plane that facilitates monitoring, managing, controlling, and redirecting user plane traffic flows such as between a WTRU and an Application Function (AF). A Network Exposure Function (NEF) enables access to 5G control plane functions to entities such as network applications and AFs which are outside of 5GS and not in the same trusted domain.

Two NFs (one as a service consumer and the other as a service producer) can communicate with each other directly without any entity in the middle or indirectly via a Service Communication Proxy (SCP). The SCP is responsible for forwarding and routing messages between an NF service consumer and an NF service producer. In addition, two NFs can interact with each other using a Request/Response mode or Subscribe/Notify model. In the Request/Response model, an NF service consumer sends a request to a NF service producer; then, the NF service producer processes the request and sends a response to the NF service consumer. In the Subscribe/Notify model, an NF service consumer first sends a subscription request to the NF service producer; then, the NF service producer processes the subscription request and stores the subscription information. Further, whenever any subscribed event occurs, the NF service producer sends a notification to the NF service consumer.

5GC also provides data storage and analytics services through functions like a Unified Data Management (UDM), a Unified Data Repository (UDR), an Unstructured Data Storage Function (UDSF) and a Network Data Analytics Function (NWDAF). Another critical feature of 5GS is network slicing, which is facilitated by a Network Slice Selection Function (NSSF).

### SUMMARY

Methods and apparatus of cross-domain trust collaboration in wireless communication are disclosed herein. In an example, a function entity (FE) receives an FE trust registration request notification from a first network node, including contact information of the first network node. The FE sends an FE trust registration request to the first network node, including contact information of external trust management functions (eTMFs), and an identifier of the FE. Further, the FE receives an FE trust registration response from the first network node, including one or more of: an identifier of an FE profile for the FE, an identifier of the eTMFs, an identifier of eTMF profiles, an association of the FE profile and the eTMF profiles, or an identifier of the first network node. Moreover, the FE sends an FE trust registration completion notification to a selected eTMF of the eTMFs, based on the FE trust registration response. In an example, the FE trust registration completion notification includes the identifier of the first network node, an identifier of the selected eTMF, and the identifier of the FE.

Additionally or alternatively, an internal Trust Management Function (iTMF) is in the first network node. Additionally or alternatively, the iTMF operates within a current public land mobile network (PLMN) for the WTRU. Additionally or alternatively, the one or more eTMFs operate outside of the current PLMN for the WTRU.

Additionally or alternatively, the FE trust registration request further includes an identifier for each of the one or more eTMFs. Additionally or alternatively, the identifier of the FE is an internal identifier. Additionally or alternatively, the identifier of the FE is an external identifier.

Additionally or alternatively, the FE profile for the FE is a profile created by the first network node for the FE. Additionally or alternatively, the one or more eTMFs have trust collaboration relationships with the first network node. Additionally or alternatively, the one or more eTMF profiles are profiles of trusted eTMFs created by the first network node.

Additionally or alternatively, the FE is a wireless transmit/receive unit (WTRU). Additionally or alternatively, the selected eTMF is in a second network node.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example cross-domain interaction scenario;

FIG. 3 is a signaling diagram illustrating an example service flow for one or more external domains providing trust information about a WTRU to one or more internal domains;

FIG. 4 is a signaling diagram illustrating an example of integrated FE trust registration and cross-domain trust collaboration establishment;

FIG. 5 is a mapping diagram illustrating an example of a ServiceID to Trust Information (TINFO) mapping;

FIG. 6 is a signaling diagram illustrating an example of FE trust registration triggered by cross-domain trust collaboration establishment;

FIG. 7 is a signaling diagram illustrating an example of trust registration triggering cross-domain trust collaboration establishment;

FIG. 8 is a signaling diagram illustrating an example of cross-domain trust collaboration establishment;

FIG. 9 is a signaling diagram illustrating an example of integrated WTRU registration and WTRU trust registration; and

FIG. 10 is a signaling diagram illustrating an example of WTRU registration followed by WTRU trust registration.

### DETAILED DESCRIPTION

As discussed herein, one or more abbreviations in the following (non-exhaustive) list, shown in Table 1, may be used herein.

TABLE 1

| | |
|---|---|
| 3GPP | 3rd Generation Partnership Project |
| 5G | 5th Generation |
| 5GC | 5G Core Network |
| 5GS | 5G System |
| 6G | 6th Generation |
| 6GC | 6G Core Network |
| 6GS | 6G System |
| Addr | Address |
| AF | Application Function |
| AMF | Access and Mobility Management Function |
| AS | Access Stratum |
| ASP | Application Service Provider |
| AUSF | Authentication Server Function |
| DN | Data Network |
| FE | Function Entity |
| FESC | Function Entity Service Consumer |
| FESP | Function Entity Service Producer |
| GPSI | Generic Public Subscription Identifier |
| GUTI | Globally Unique Temporary Identity |
| ID | Identifier |
| LMF | Location Management Function |
| ME | Mobile Equipment |
| MNO | Mobile Network Operator |
| NAS | Non-Access Stratum |
| NEF | Network Exposure Function |
| NF | Network Function |
| NFP | Network Function Producer |
| NPN | Non-Public Network |
| NRF | Network Repository Function |
| NWDAF | Network Data Analytics Function |
| PCF | Policy Control Function |
| PDU | Protocol Data Unit |
| PLMN | Public Land Mobile Network |
| SA | Service Architecture |
| SBA | Service-Based Architecture |
| SBI | Service-Based Interface |
| SEAF | Security Anchor Function |
| SIDF | Subscription Identifier De-concealing Function |
| SUCI | Subscription Concealed Identifier |
| TIDC | Trust Indicator |
| TIDX | Trust Index |
| TINFO | Trust Information |
| TMF | Trust Management Function |
| iTMF | internal Trust Management Function |
| eTMF | external Trust Management Function |
| UDM | Unified Data Management |
| UDR | Unified Data Repository |
| UDSF | Unstructured Data Storage Function |
| WTRU | User Equipment |
| URI | Uniform Resource Identifier |

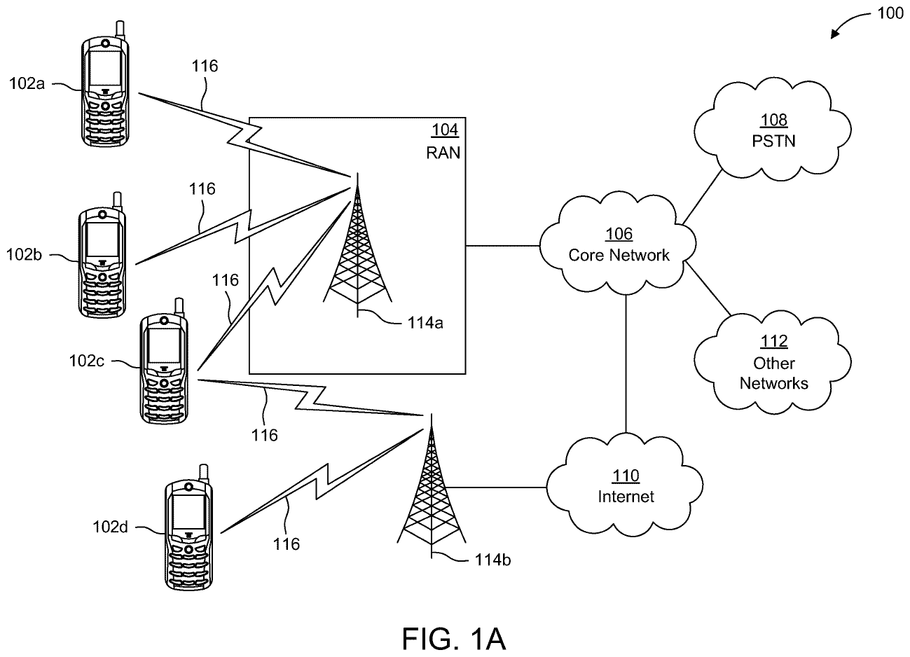

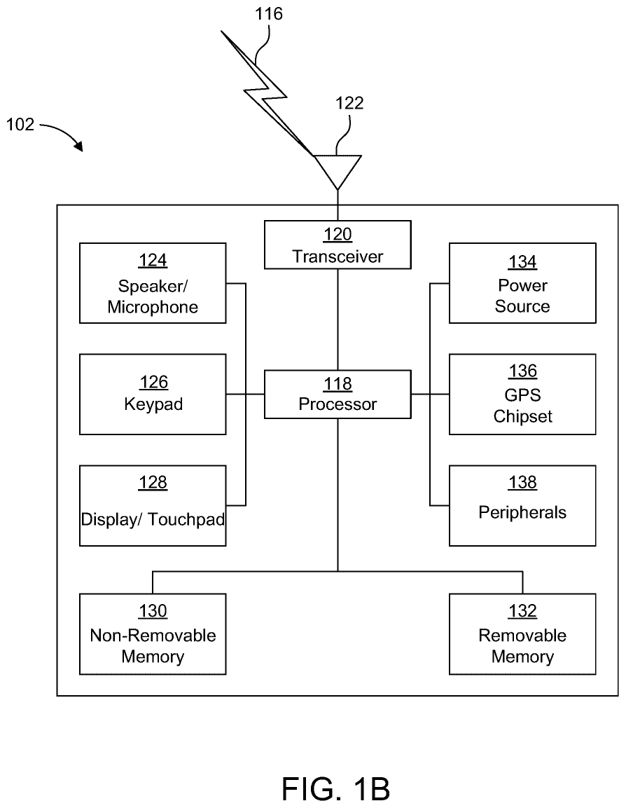

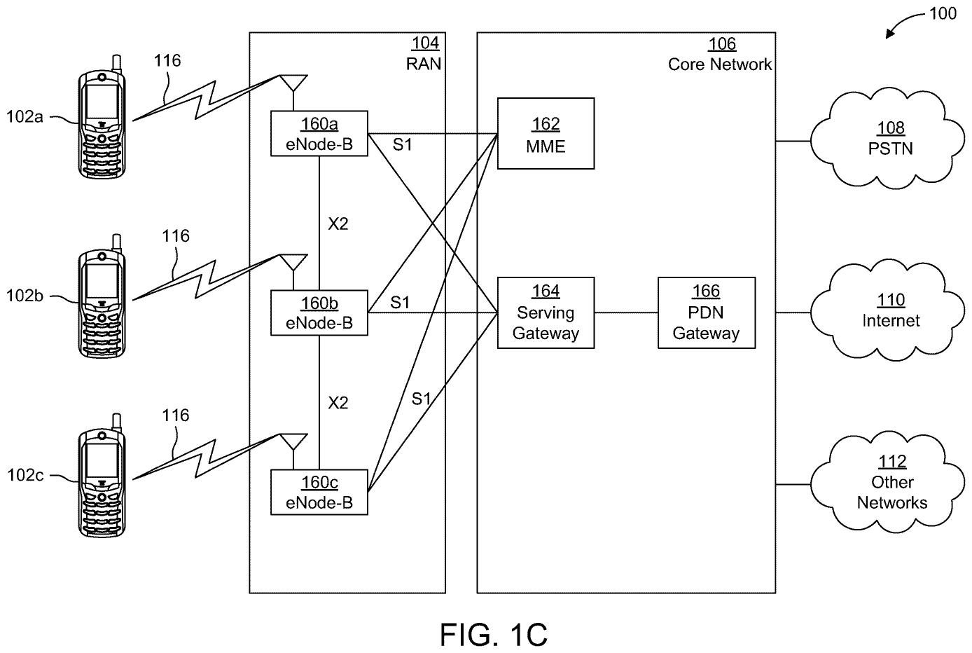

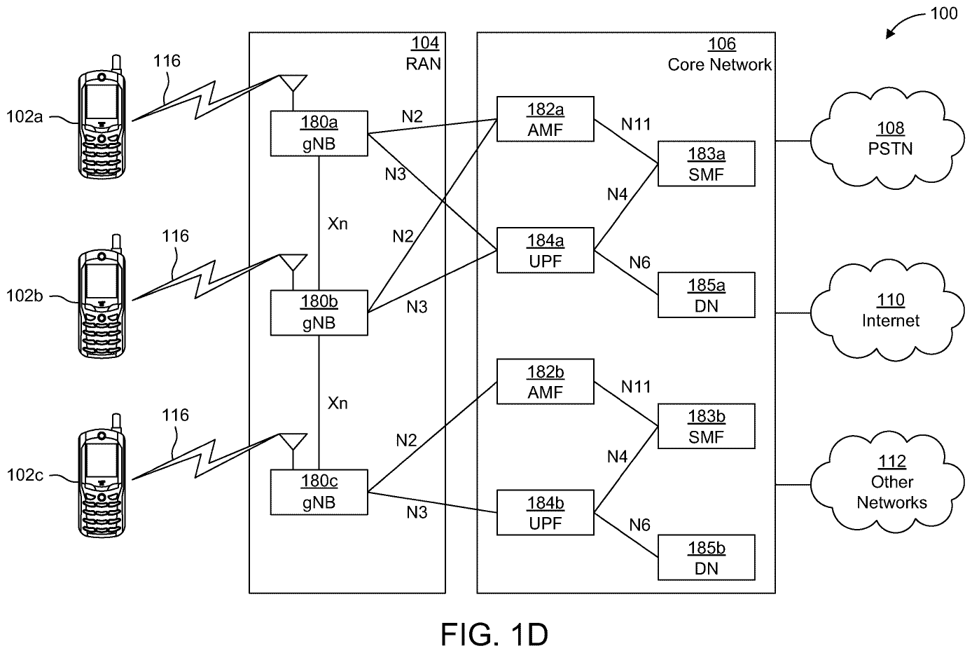

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The Fifth Generation System (5GS) introduces a few network functions such as a Location Management Function (LMF) to support location services. The LMF is responsible for calculating, determining, or verifying a final location and any velocity estimation and may estimate the achieved accuracy, based on location information from the subject WTRU and/or a RAN node. After the LMF calculates the location of a subject WTRU, other entities can access or query its location from LMF but need to go through a serving AMF.

Although these network functions are defined as separate logical entities, a particular service scenario may require multiple network functions; for instance, WTRU mobility will need not only an AMF, but also an Authentication Server Function (AUSF) and SMF. For a type of network function, multiple instances could be instantiated and a Network Repository Function (NRF) will maintain the information of each instantiated network function instance. With the emergence of edge computing, some network functions in 5GC such as UPF and Network Exposure Function (NEF) could be deployed and resided in an edge network that is much nearer to and potentially co-located with the RAN.

Existing cellular wireless systems (e.g., 5GS) provide various security functions as defined in 3GPP TS 33.501, which is incorporated by reference in its entirety as if fully set forth herein. These various security functions include, for example, primary authentication during registration, secondary authentication during Protocol Data Unit (PDU) session establishment, network function (NF) service authorization, network slicing-specific authentication and authorization, network slicing admission control, data plane encryption and integrity protection, and the like.

NF Service authorization in 5GS can be static authorization or token-based authorization. In static authorization, some local authorization policies are maintained at the NRF and NF service producer. Those local authorization policies are used to authorize a NF service consumer, when the NF service consumer discovers NF service producers from NRF or when it requests to access services from a discovered NF service producer.

In token-based authorization, NRF can grant an access token to a NF service consumer. Then, the NF service consumer presents the access token to the NF service producer, which will authorize the NF service consumer based on the access token.

Examples of trust evaluation and management are provided herein. Trust refers to a measurable belief that represents an accumulated value (e.g. about the quality/behavior/performance/characteristic of a network node, a WTRU, a service or any logical/physical entity) from history and the expected value for the future. Trust can be objective trust or subjective trust. The objective trust leverages the security mechanism, such as authentication, to validate an entity's identity. However, trust covers and is beyond security. For example, an entity passing the authentication only means the entity has successfully proved its identity. The entity still may not be fully trusted since the trust about the entity's behavior/characteristics could still be dynamically changing and the criteria for evaluating trust may also be subjective, for example, based on user/personal experience/preference. Trust is an essential input for decision making and it is usually measured or calculated based on the history experience/records in the past, and it represents the expected value of quality, behavior, characteristics, and/or performance in the future.

A Trust Index may be obtained via a Trust Evaluation process. A trust index can be used to describe the trust of an entity. The trust index is an overall metric, which is often calculated based on the aggregation of one or more Trust Indicators (depending on the user's subjective trust evaluation criteria) using certain trust evaluation algorithms. The trust indicators may cover various aspects, such as security, privacy, resilience, performance, robustness, scalability, availability, accuracy, reliability, consistency, and the like. During a trust evaluation process, various data about an entity can be collected and those data could be used as inputs to calculate various trust indicators, which in turn are aggregated into an overall metric, i.e. the current trust index of the entity. Trust has various characteristics. For example, trust is dynamic, meaning that a given trust index may be applicable for a limited time period and may change as time goes on. Trust is also context-dependent, which means that the trust can have a significant change if the context gets changed. Trust is not transitive in nature, but trust may be transitive in some particular contexts. Similarly, trust is an asymmetric relationship, meaning that a fact of entity A trusting entity B cannot deduce that entity B also trusts entity A. In addition, trust could also be subjective, which means for the same entity, different users may have different criteria/opinions/preferences regarding how to evaluate the trust of this entity and what kinds of trust-related aspects/indicators shall be considered, and the like.

Trust generation, trust evaluation, trust assessment, trust measurement, trust computation and trust calculation may be used interchangeably in this disclosure unless there is an explicit clarification. Trust index generation, trust index evaluation, trust index assessment, trust index measurement, trust index computation and trust index calculation may be used interchangeably in this disclosure unless there is an explicit clarification.

Use case regarding trust collaboration are provided herein. In future wireless systems, each device serves as a convergence point for both communication and computation. A user can access services from a network function or an external application function and, simultaneously, provide services to these entities. These services may include but not limited to Network Data Analytics Function (NWDAF), artificial intelligence (AI) as a Service (AaaS), Computation as a Service (CaaS), and Sensing as a Service (SaaS).

Dynamic user behaviors, such as moving from one public land mobile network (PLMN) or non-public network (NPN) to another, along with diverse inter-domain service combinations (for example, sharing data with an external Application Function (AF) or offloading AI tasks via an external AI broker AF) create a clear need for enhanced trustworthiness. In such scenarios, trust metrics collected in one domain must be shared with other domains to collectively determine the overall trustworthiness.

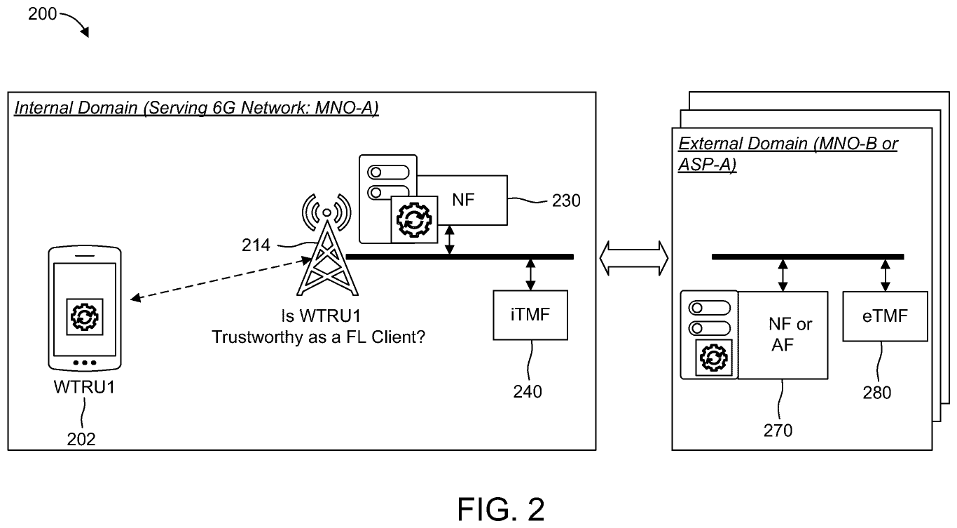

FIG. 2 is a system diagram illustrating an example cross-domain interaction scenario. As shown in an example in system diagram 200, a WTRU1 202 initiates new activity with or roams to the current Fifth Generation (5G) or future Sixth Generation (6G) network (for example, mobile network operator (MNO)-A), which can be regarded as an internal domain. Specifically, WTRU1 202 registers itself to MNO-A as a federated learning (FL) client. The WTRU1 202 communicates with network node 214, and may access NF 230 and internal trust management function (iTMF) 240. The WTRU1 202 may be the same as, or similar to, WTRU 102, in examples. Further, network node 214 may be the same as, or similar to, one or both of base stations 114a, 114b.

MNO-A needs to evaluate the trustworthiness of WTRU1 202 and determine if WTRU1 202 can be registered as an FL client. However, MNO-A does not have sufficient historical data about WTRU1 202 as an FL client. In the meantime, WTRU1 202 may have interacted with its home network (for example, MNO-B, if WTRU1 202 is in roaming) and/or an FL-oriented application service provider (for example, ASP-A) as an FL client. Thus, MNO-A can request FL-related historical data and corresponding trust information from MNO-B and/or ASP-A, which are regarded as external domain from MNO-A's perspective. In an example, the MNO-B may include an NF or AF 270 and an external trust management function (eTMF) 280. An example service flow for this scenario is provided below.

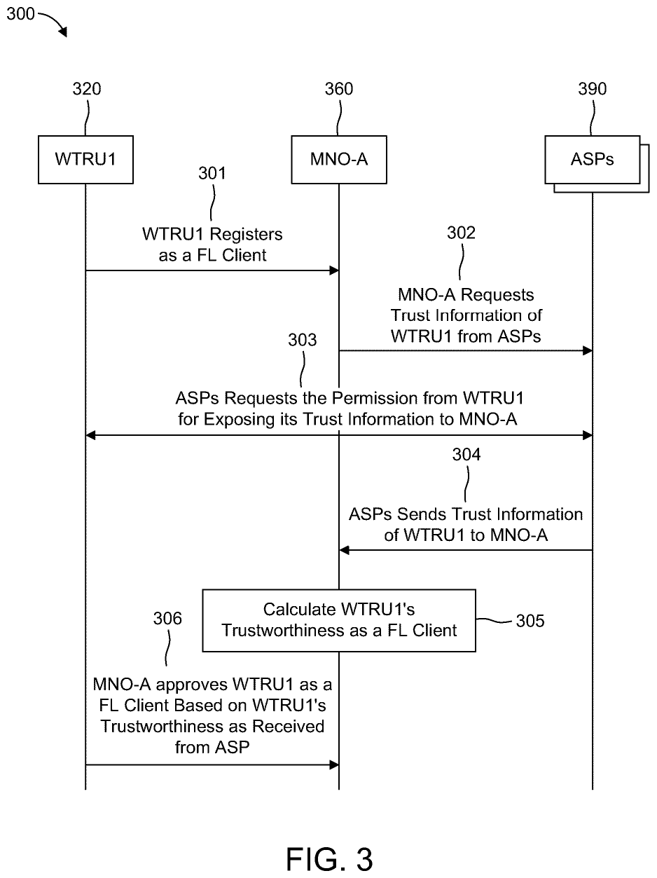

FIG. 3 is a signaling diagram illustrating an example service flow for one or more external domains providing trust information about a WTRU to one or more internal domains. As shown in an example in signaling diagram 300, WTRU1 320 registers itself as an FL client with MNO-A 360 in step 301. In step 302, The MNO-A 360 cannot determine the trustworthiness for WTRU1 320 as an FL client. For example, the honesty of an FL client cannot be assessed without long-term interaction to detect potential malicious behavior, such as injecting random gradients with malicious intent. Accordingly, MNO-A 360 contacts one of the ASPs 390, such as ASP-A, for trust assistance. In this way, MNO-A 360 requests trust information of WTRU1 320 from ASPs. If necessary, MNO-A 360 may reach out to different ASPs to gather information not available within MNO-A 360.

In step 303, ASPs such as ASP-A requests the permission from WTRU1 320 for exposing its trust information to MNO-A 360. In step 304, with the permission from WTRU1 320, ASPS such as ASP-A reviews the history of WTRU1 320 as an FL client and sends trust information of WTRU1 320 to MNO-A 360.

In step 305, MNO-A 360 evaluates the trust information from different ASPs and calculates the trustworthiness of WTRU1 320 as an FL client. Based on the trustworthiness of WTRU1 320 as an FL client, MNO-A 360 decides whether to approve WTRU1 320 as an FL client or not, and sends the decision to WTRU1 320.

When a WTRU initiates new activities in current wireless network (for example, either a home or a visited 6G network), the internal Trust Management Function (iTMF), which operates within the current wireless network serving the WTRU, may encounter difficulties in evaluating the trustworthiness of the WTRU due to the lack of prior interaction history. For example, if the WTRU attempts to register to the current wireless network as a federated learning (FL) client, especially for the very first time, the iTMF may be unable to determine whether the WTRU is a legitimate FL participant or a malicious one, as there is insufficient historical data that the iTMF can leverage to make an informed decision on the trustworthiness of the WTRU from a FL perspective.

Accordingly, how an iTMF can know corresponding eTMFs that can provide additional trust information about a WTRU, a device function/service, or a user is a problem addressed by embodiments and examples provided herein. Further, how an iTMF and eTMFs can build a trust collaboration relationship, which can efficiently facilitate future trust information exposure from eTMFs to the iTMF, is another problem addressed by embodiments and examples provided herein.

The following terms are applicable to the proposed solutions in the embodiments and examples provided herein. A Function Entity (FE) may refer to a processing function, such as one or more network functions specified in 3GPP TS 23.501, which is incorporated by reference in its entirety as if fully set forth herein. This FE may also serve as an AF, an edge application or service, a device-provided service, a device-hosted application, or a server or service within a data network, among other possibilities.

An FE Service Consumer (FESC) may refer to an FE that accesses services provided by FE service producers (for example, an NF service producer as defined in 3GPP TS 23.501). An FE service consumer may be an NF service consumer as defined in 3GPP TS 23.501, an AF, an edge application or service, a device-hosted application, or a server within a data network. A device may be a FESC. A single device may have multiple FESCs.

An FE Service Producer (FESP) may refer to an FE that provides services to FE service consumers. An FE service producer may be an NF service producer as defined in 3GPP TS 23.501, an AF, an edge application or service, a service enabler, or a service on another device. A device may be an FESP. A single device may have one or multiple FESPs.

A Trust Management Function (TMF) may be an FE that can assess and calculate the trust index for other entities including but not limited to a device, a user, an AF, an NF, a service, or an application. The TMF can assess and calculate the trust index of FESCs and FESPs. The TMF can also expose the calculated trust index to other FEs within the same domain. When sharing trust-related information with other TMFs across domains, the TMF requires permission from the subject entity (for example, a FE).

A domain refers to a self-governing operational environment with control over its internal resources, services, and policies. Examples of domains include but not limited to a PLMN (for example, a public network), a NPN (for example, a non-public network), a cloud service provider, an application service provider, an AI service provider, an internet service provider, or a social media platform. Cross-domain interactions occur when two or more domains collaborate or exchange information, such as PLMN-to-PLMN interactions or communications between a PLMN and an AF with a DN.

The terms iTMF and eTMF are defined relative to the domain in which the WTRU is currently connected. The iTMF operates within the current PLMN or NPN that WTRU is currently connected to and manage trust evaluations and service access decisions for that domain. In contrast, the eTMF resides outside the current PLMN and may belong to another domain such as but not limited to another PLMN, a cloud service provider, an application service provider, an AI service provider, an internet service provider, or a social media platform. The iTMF may actively/passively collaborate with other eTMFs to obtain additional trust information and/or historical data about the WTRU's trustworthiness.

An Identifier may refer to the name/identifier/address of an entity (for example, a user, a device, a FE, an entity using a device, and so forth). An identifier may be a 3GPP identifier, an IP address, a Uniform Resource Locator (URL), a Fully Qualified Domain Name (FQDN), a blockchain address, a distributed user identifier, and so forth. The identifier of an entity enables or gives access details based on which other entities can access and interact with this entity.

A Trust Index (TIDX) may refer to a quantitative measure representing the trust level or trustworthiness of an FE within a specified range or scale. A TIDX is generated by a TMF as the result of its trust evaluation. During this process, a confidence value may be also computed, which reflects the certainty or reliability of the trust assessment. However, this confidence value may not be shared with FEs. FEs can utilize the TIDX to determine their level of service accessibility or eligibility to interact with other FEs.

A Trust Indicator (TIDC) may refer to a set of trust metrics or key performance indicators (KPIs) that provide a multi-faceted assessment of trust. These indicators evaluate the performance of an FE from various perspectives, such as throughput, latency, scalability, and other operational metrics. Unlike TIDX, which provides an overall trust score based on a set of TIDCs, a TIDC focuses on specific and measurable performance dimensions that contribute to the overall trust evaluation. The exact KPIs included in the TIDC are service-dependent, meaning they vary according to the specific requirements and characteristics of the service being accessed, requested or provided.

Trust Information (TINFO) may refer to a general term representing trust-related data associated with an FE. It serves as an overarching concept that can refer to a TIDX, a TIDC, and/or any other trust-related information, depending on the specific service context.

A Trusted Party (TP) may refer to a trusted intermediary that is mutually trusted by two different parties. Its role is to bridge the trust gap between the two parties by transferring the trust of one party to the other.

A Service identifier (ID) (ServiceID) may refer to an identifier, name, or type of the target service and/or the specific service operation involved in trust index calculations, where a trust index may be calculated per ServiceID for a FESC or a FESP. Different service operations within the same service may be each assigned a unique ServiceID. These service operations may include but not limited to service discovery, service initialization, service access, service information retrieval, service offloading, service adjustment, service subscription management, and service cancellation.

As used in examples herein, a wireless network may be a PLMN, an NPN, a WiFi network, a Customer Premises Network (CPN), a Personal IoT Network (PIN), a Vehicular-to-Everything (V2X) network, a connected robot network, an Aircraft-to-Everything (A2X) network, and so forth. A wireless network serving an FE is referred to as a serving wireless network, which may be a visited wireless network or a home wireless network. A wireless network may be a 5GS or a 6GS. A wireless network may be a part of 5GS or 5GS.

The following design principles drive the proposed solutions with some unique or rare benefits. Steps to expose trust information of a subject FE (for example, WTRUs, users, applications, services, and so forth) from an eTMF to an iTMF should inform and be approved by the subject FE. Potential benefits of doing this include: 1) controllability by the subject FE; and 2) privacy protection for the subject FE.

Trust collaboration establishment between an iTMF and an eTMF should be a prerequisite before exposing trust information of a subject FE between them. Potential benefits of doing this include: 1) secure trust information exposure; and 2) exposed trust information can be trusted.

Trust information exposure should be flexible and should not be limited to or controlled by a single entity (iTMF, eTMF, or the subject FE). In other words, any of the iTMF, eTMF or subject FE should be able to initiate or trigger trust information exposure from an eTMF to an iTMF. Potential benefits of doing this include: 1) Flexible trust information exposure; and 2) Avoid single point of failure.

If information elements or parameters can be preconfigured or previsioned, they do not need to be transmitted over the interface between two FEs. Potential benefits of doing this include: 1) reduced communication overhead; 2) reduced information leakage and improved security; and 3) reduced communication message processing overhead.

For a WTRU engaging in new activities with or roaming to the current PLMN, embodiments and examples provided herein include that an iTMF of the current PLMN can request assistance from an eTMF. The eTMF could be the TMF of the WTRU's home PLMN during roaming or an external function within the DN. Since the eTMF may possess historical interaction records of the WTRU, the iTMF can leverage such information to support its trustworthiness evaluation of the WTRU.

Embodiments and examples provided herein include FE trust registration and cross-domain trust collaboration establishment. In an example solution, before sharing trust information about FEs (for example, WTRUs, users, applications, services, and so forth) across different domains, cross-domain trust collaboration needs to be established. Also, the internal and external domains that an FE is involved should be correlated and known to wireless system (for example, 6GS). Three example approaches are provided below to solve the issues related to how to establish cross-domain trust collaboration among TMFs in separate domains for specific FEs. The main ideas in those approaches include two components.

A first component includes FE trust registration. For example, an FE registers with an iTMF for trust management and may indicate one or multiple eTMFs that may assist the iTMF in its trust management. During the FE registration, the iTMF will create a FE profile and may initiate trust collaboration establishment with eTMFs.

A second component includes Trust Collaboration Establishment. For example, an iTMF and an eTMF build a trust collaboration relationship so that an eTMF can provide trust information about an FE to the iTMF. The iTMF and the eTMF may create and maintain each other's profile (TMF profile) locally.

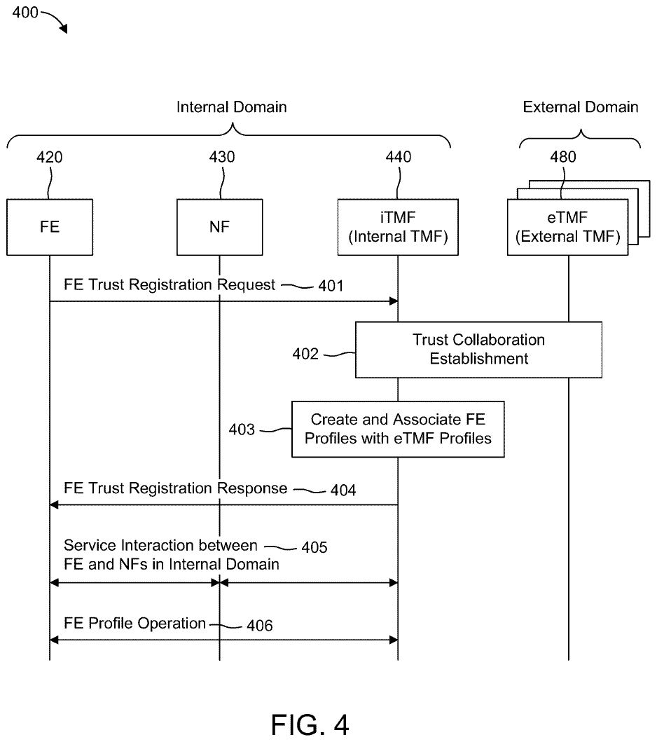

The three examples approaches include the following. A first example approach includes integrated trust registration and cross-domain trust collaboration establishment. In an example, an FE initiates FE trust registration with an iTMF, which will then trigger trust collaboration establishment with corresponding eTMFs that can provide trust information about the FE. The eTMFs may be indicated by the FE to the iTMF or be pre-configured in the iTMF. An example of this approach is shown in FIG. 4, further below.

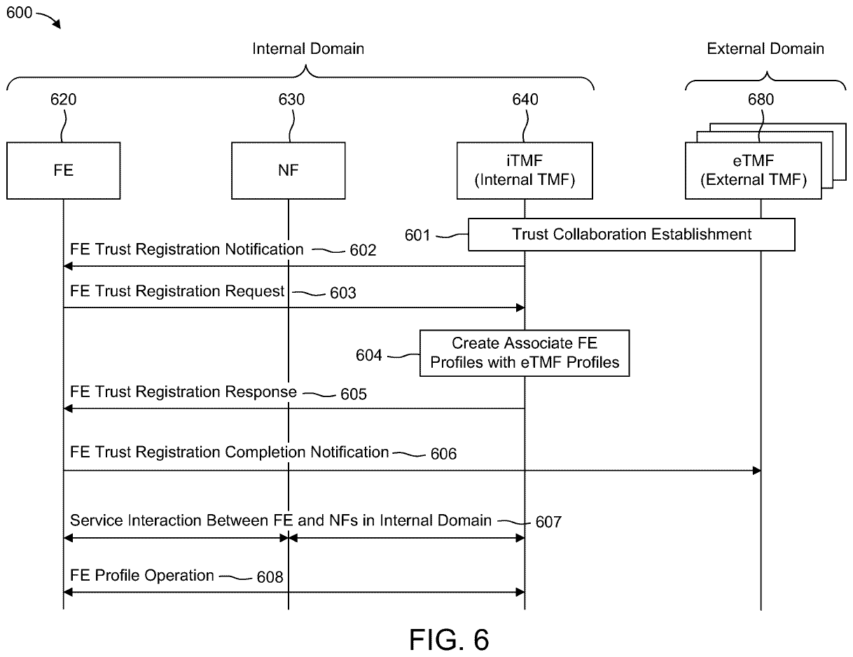

A second example approach includes when cross-domain trust collaboration establishment triggers FE trust registration. In an example, an iTMF and an eTMF first establish a trust collaboration relationship, which can be applied to one or multiple FEs. Then, the iTMF notifies an FE to perform FE trust registration with the iTMF. During FE trust registration, the iTMF will create an FE profile and associate it with an existing eTMF profile. After FE trust registration, the FE may send a notification to the corresponding eTMF which can provide its trust information to the iTMF. An example of this approach is shown in FIG. 6, further below.

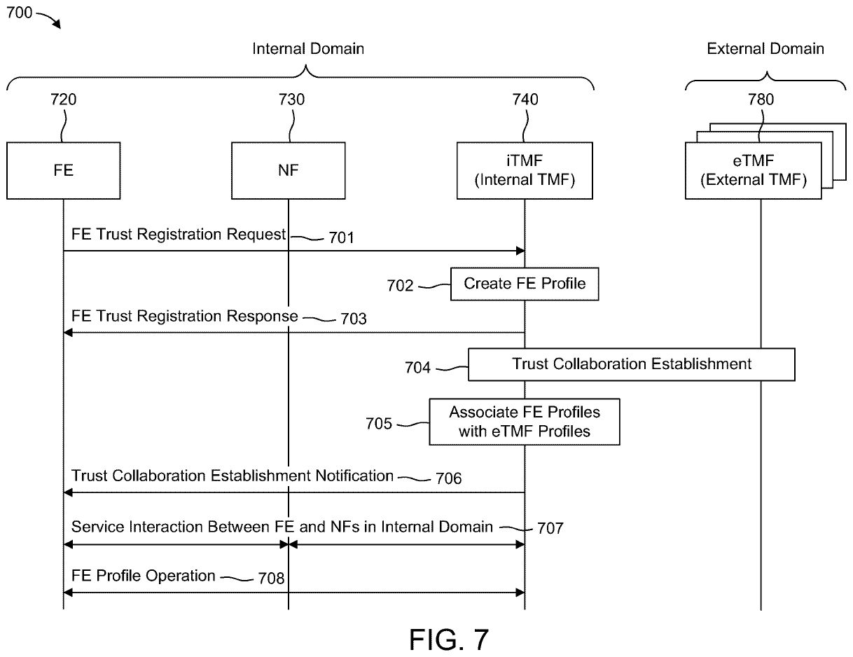

A third example approach includes when FE trust registration triggers cross-domain trust collaboration establishment. In an example, an FE first performs FE trust registration with an iTMF. During FE trust registration, the iTMF will create an FE profile. After FE trust registration is completed, the iTMF starts to build trust collaboration with the corresponding eTMF which can provide trust information of the registered FE. An example of this approach is shown in FIG. 7, further below.

FIG. 4 is a signaling diagram illustrating an example of integrated FE trust registration and cross-domain trust collaboration establishment. An example procedure outlined in signaling diagram 400 includes the following logical elements or actors. An FE 420 is in an internal domain, which may be a WTRU or an FE on WTRU. This FE 420 is a requestor FE or a registering FE. The FE 420 may engage with several external AFs integrated with an eTMF or other PLMN, which can assist in TIDX generation and/or conduct any trust-related support to establish mutual trust relationships with other FEs. An NF 430 may interact with FE 420 at Step 405, in an example, the details of which are explained further below.

An iTMF 440 is in the internal domain, for example, a 6G serving network. Further, one or more eTMFs 480 are TMFs in external domains (for example, a DN, 6G home network of FE such as a PLMN or an NPN).

Steps 401 to 404 outline the procedure for registering an FE to an iTMF. Steps 1-4 can also apply to other FEs and any other devices having interactions with external domains (for example, AFs in a DN), provided that each external domain includes a TMF (for example, an eTMF) to facilitate FE TIDX calculation or FE TIDX generation.

In Step 401, FE 420 may send an FE trust registration request to the iTMF. The request could also be a FE trust registration update request, to update previously registered information as contained in an existing FE Profile. This request may contain the following information.

The request may include an FEID which is the identifier of the requestor FE or registering FE. Further, the request may include an FEProfileID which is the identifier of the FEProfile that this FE trust registration request aims to update. Also, the request may include an FECredential which is the credential of the requestor FE which will be used in Step 402 to authorize this FE trust registration request.

Additionally, the request may include an FEContext. For example, the requestor FE 420 may attach factors that could contribute to the generation of TIDX. The iTMF 440 may directly retrieve some of these factors from other WTRUs, NFs, or AFs in the internal domain. These factors could be one or more of: FELocation: physical, network, or geo location of the requestor FE; FEConnectionType: the type of various connections (for example, cellular, Wi-Fi, satellite) that the requestor FE is currently connected or previously connected to internal domain (for example, a serving wireless network); FEPowerSupplySource: Powered by battery, cable, solar, and so forth; FEType: Being an IoT device, smart phone, vehicle, drone, aviator, robots, and so forth; or FEHardwareSpecification: Indicate the type/model/capability/size of memory, the type/capability/model of the computing processor, the type/model/capability/size of storage, and so forth.

In addition, the request may include an EDLst (external domain list) which contains a list of eTMFs along with the requestor FE's external ID recognizable to the eTMF 480. An FE may access different services from various external domains which can involve interactions with eTMFs in those domains; these interactions may serve multiple purposes, including, but not limited to, entity registration, entity monitoring, and handling entity TINFO requests. When an FE registers with an iTMF, any TMFs operating outside the domain of iTMF may be classified as eTMFs. The requestor FE may include each eTMF as an element in EDLst. EDLst will be passed to iTMF during FE trust registration request. Each element of EDLst is a pair of the following two parameters. One parameter is an ExternalTMFID, which is the identifier (or the name, FQDN, and so forth) of an eTMF of an external domain. This identifier may also include the Domain ID, which provides contextual information about the domain to which the eTMF belongs. This parameter may contain the address and/or contact information of the eTMF, through which the eTMF can be contacted. Another parameter is FEExternalID, which is the identifier of the requestor FE in the same external domain. The FEExternalID may be a general public subscription identifier (GPSI) if the FE is a WTRU.

Further, the request may include a DefaultTMF. In the request, the requestor FE may indicate a default TMF other than the iTMF as the entity for managing its trust. By using the same TMF for trust generation, a consistent TIDX is more likely to be produced and maintained, enabling smoother service continuity. When presented with such a parameter, iTMF may be instructed by a policy (could be from a Policy Control Function (PCF)) to designate itself as the default TMF preventing the use of an external TMF as the default TMF. Additionally or alternatively, the iTMF might choose to accept the requestor FE's eTMF (DefaultTMF) as the default TMF and offload TIDX generation to it, considering TIDX generation may require significant computational resources and incurs substantial communication costs.

Moreover, the request may include a ServiceIDLst which may be a list of Services (for example, each ServiceID represents a service) that the FE may request later from the internal domain (for example, from the NF or other NFs) and the iTMF may need to later evaluate FE's trust index before any requested service is provided to the FE.

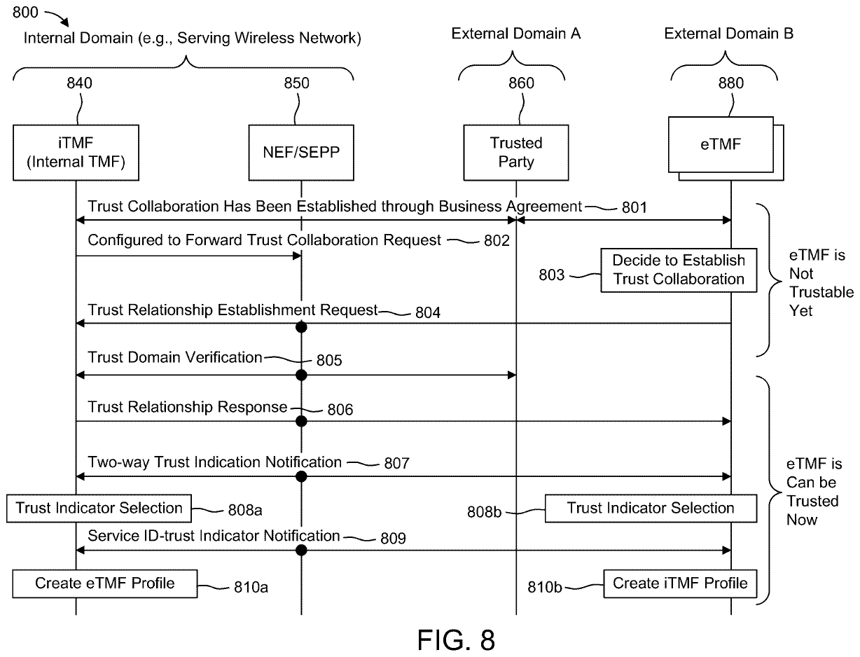

In Step 402, after the iTMF 440 receives the FE trust registration request, trust collaboration between the iTMF 440 and eTMFs 480 may need to be established. In practice, trust collaboration is a relatively independent process and may be initiated and completed in advance of receiving the FE trust registration request. Additionally or alternatively, trust collaboration can also be performed after completing the FE trust registration (for example, after step 404). By pre-establishing the trust collaboration with potential eTMFs 480, the iTMF 440 can reduce delays during FE trust registration and enable faster response times and more efficient processing of FE trust registration requests. Trust collaboration can be initiated by either an iTMF 440 or an eTMF 480, or other entities. The following description assumes the FE 420 promoting the iTMF 440 to initial trust collaboration with the eTMF 480. The other case, where an eTMF 480 may initialize trust collaboration to an iTMF 440, can be found in FIG. 8. Step 402 may be repeated multiple times (for example, one for a different eTMF).

In an example, the iTMF 440 may use Step 402 to build trust collaboration with eTMFs 480, not only for collaborative trust evaluation for the FE on FIG. 4, but also for other FEs and/or a specific sets of services/requests (not shown on FIG. 4). In this case, the identifiers of those other FEs/services/requests may be indicated and exchanged between the iTMF and each eTMF.

Step 402 may include the following sub-steps for trust collaboration establishment. In a Sub-step 402.1 for FE Credential Validation, the iTMF may first verify FECredential in order to authorize the FE trust registration request. As an example, this validation can be carried out by the iTMF by contacting another NF (for example, a Unified Data Management (UDM) or an AUSF) to verify the credential. Upon successful verification, the requestor FE is recognized as an authorized FE, allowing it to proceed with trust registration. Subsequently, the iTMF is enabled to establish trust collaboration with the eTMFs in the EDLst.

In a Sub-step 402.2 for mutual trust between TMFs, the iTMF may use the EDLst to select one more eTMFs according to some pre-configured policies (and/or new policies that the iTMF 440 may retrieve from an NF such as a PCF) and establish the mutual trust with each selected eTMF, as the prerequisites for trust collaboration. An example of eTMF selection policy is to select only one eTMF for an IoT-type WTRU. Another example of eTMF selection policy is to select multiple eTMFs for a vehicle-type WTRU. Each side could initialize mutual trust request, and then the other side sends a response. Mutual trust establishment may be established with the aid of a TP list. This TP list may include a list of TPs such as well-known service providers, such as wireless providers, video streaming service provider, game producers, cloud computing providers, social media operators, original equipment manufacturers (OEMs), and so forth. It is assumed that the iTMF has established a trust relationship with those TPs; in other words, the iTMF trusts these TPs. Then, if an eTMF is trusted by a TP, the iTMF can trust the eTMF too after certain procedures.

In an example where the iTMF is to trust the eTMF, the iTMF can trust an eTMF using different technologies. For example, the iTMF can verify the integrity of eTMF executing code and build environment with remote attestation leveraging a TP as a verifier. Alternatively, an iTMF can trust the eTMF based on a pre-configured trusted TMF list maintained by the iTMF. This list identifies the eTMFs that are considered trustworthy.

In an example where an eTMF is to trust the iTMF, the eTMF can trust the iTMF based on a pre-configured trusted TMF list maintained by the eTMF. This list identifies the iTMFs that are considered trustworthy. Additionally or alternatively, the eTMF can verify the integrity of the iTMF executing code and build environment with remote attestation leveraging a TP as a verifier.

Possible further procedures include the following. In an example where the iTMF sends a mutual trust request including its ID to the eTMF. The eTMF may determine, using the received iTMF ID in the request that the iTMF is in its trusted list. But in order to verify the request is truly from iTMF, the eTMF may need to verify the mutual trust request with a Certificate Authority (CA) server (which is a TP trusted by eTMF).

Additionally or alternatively, the eTMF submits its own evidence (for example, the certificate of eTMF) to iTMF and notifies iTMF that its iTMF ID has been verified. Additionally or alternatively, the iTMF verifies the evidence with a TP (trusted by iTMF, could be a verifier in remote attestation). Additionally or alternatively, the iTMF sends a mutual trust response to eTMF announcing mutual trust is now established.

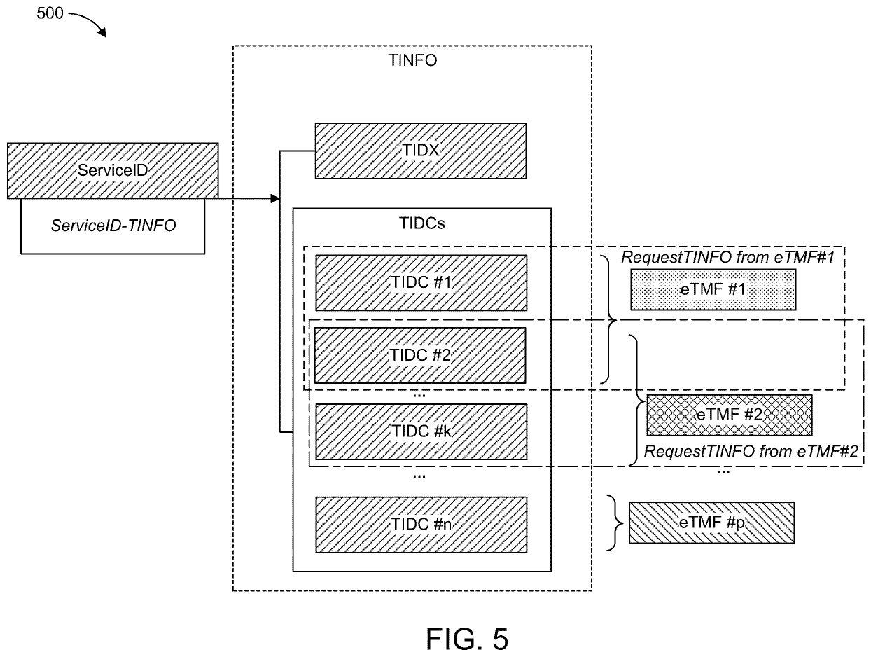

In a Sub-step 402.3 for trust collaboration details, once mutual trust is established, both parties (i.e., the iTMF and an eTMF) begin negotiating the specifics of their trust collaboration. Collaboration could be symmetric, both sides can provide trust assistance to each other. Collaboration could be asymmetric, where only eTMFs provide external trust assistance to iTMF, while iTMF does not provide trust assistance to eTMFs. Details can be found in FIG. 5 below.

The Sub-step 402.3 may include a ProvidedTrustIndicator. Generating a TIDX is a default capability required for all TMFs. However, providing specific TIDCs may depend on the TMF. A ProvidedTrustIndicator at a TMF (either an iTMF or an eTMF) about an FE may be indicated by the FE to the TMF (for example, during FE Trust Registration Request) and/or determined by the TMF. Therefore, when TMFs share their capability information as a part of negotiating the specifics of their trust collaboration, they only need to indicate the specific TIDCs they can provide in addition to the TIDX. This requirement is also reflected in the naming of the ProvidedTrustIndicator. In this context, an eTMF may send its trust indicators (i.e., ProvidedTrustIndicator) to the iTMF, and the iTMF may respond with its trust indicators (i.e., ProvidedTrustIndicator) to the eTMF, or vice versa. Additionally or alternatively, the iTMF sends a request to an eTMF, which will return a list of its trust indicators (i.e., ProvidedTrustIndicator) to the iTMF. Similarly, the iTMF may push its trust indicators (i.e., ProvidedTrustIndicator) to an eTMF, or wait for the eTMF to retrieve or pull them. This exchange enables both sides to understand the scope and nature of the trust metrics available for request and utilization. By sharing trust indicators, the TMFs facilitate transparent and efficient trust-based interactions.

The iTMF's Trust Indicators (i.e., ProvidedTrustIndicator) may be shared to the eTMF and may be typically related to FE connectivity, such as network stability, latency, and signal strength. Trust Indicators at the iTMF may cover various aspects of the FE, such as security, privacy, resilience, performance, robustness, scalability, availability, accuracy, reliability, consistency, and so forth.

The eTMF's Trust Indicators (i.e., ProvidedTrustIndicator) shared to iTMF. The Trust Indicators may include FE device performance metrics: computational power, energy consumption, resource availability (CPU, GPU, or battery status) relevant for collaborative tasks, and the like. Further, the Trust Indicators may include an FE device security posture, such as results of remote attestation, presence of secure enclaves, and tamper resistance hardware. Also, the Trust Indicators may include FE Federated Learning (FL) Participation Metrics, such as training data diversity, FL client contribution score, and/or FL honesty index. Moreover, the Trust Indicators at eTMF may cover various aspects of FE, such as security, privacy, resilience, performance, robustness, scalability, availability, accuracy, reliability, consistency, and so forth.

FIG. 5 is a mapping diagram illustrating an example of a ServiceID to Trust Information (TINFO) mapping. As shown in an example in the left side of mapping diagram 500, a ServiceID-TINFO may be a local parameter that is independently created and maintained by each TMF (either an iTMF or an eTMF). Each TMF may or may not have a unique ServiceID. TMFs are not directly requesting ServiceID from other TMFs, but requesting the TINFO provided by other TMFs indicated in ProvidedTrustIndicator. So, each TMF locally maps its ServiceIDs to specific trust information or trust indicators (which could be provided by the other TMFs in the ProvidedTrustIndicator). Besides, the trust indicators after the mapping can be requested from different TMFs. For the example in FIG. 5, when a TIDX request about the ServiceID reaches an iTMF, the iTMF can decompose the ServiceID into a TIDC/TIDX (RequestTINFO) using ServiceID-TINFO. And then the iTMF requests TIDC/TIDX (RequestTINFO) from corresponding eTMFs by mapping RequestTINFO with ProvidedTrustIndicator, which is TIDC #1 and TIDC #2 from eTMF #1, and TIDC #2 through #k from eTMF #2, as two examples.

A mapping of ServiceID to Trust Indicators (TIDC) may include that each ServiceID is linked to one or more trust indicators. In this case, TIDC is requested in the external trust request (e.g., to be sent from an iTMF to an eTMF). For example, in ‘ServiceID=FL_Client_Registration’, the corresponding trust indicators may include: TIDC #1: FE/WTRU connectivity; TIDC #2: FE/WTRU FL client training data diversity; TIDC #3: FE/WTRU FL client contribution score; and TIDC #4: FE/WTRU honesty index (measured with long-term interaction).

A mapping of ServiceID to Trust Index (TIDX) may include that in some cases, a TIDX may be used instead of individual trust indicators. In this case, TIDX is requested in the external trust request (e.g., to be sent from an iTMF to an eTMF).

The Sub-step 402.3 may further include an ExternalServiceID-TINFO. After confirming the ServiceID-TINFO, the iTMF may send a trust sharing request to the eTMF, including a portion of ServiceID-TINFO, to request that the eTMF store this shared information as ExternalServiceID-TINFO. The shared portion allows the eTMF to clearly understand how the ServiceID from the iTMF are linked to the specific trust indicators that the eTMF can provide. Similarly, the eTMF can also share a portion of its ServiceID-TINFO with the iTMF, following the same approach.

Further, the iTMF and eTMF share a list of external ServiceIDs and associate them with their corresponding trust indicators. Continuing using the FL registration example, the iTMF can provide: TIDC #1: FE/WTRU connectivity. Further, the eTMF may provide one or more of: TIDC #2: FE/WTRU FL client training data diversity; TIDC #3: FE/WTRU FL client contribution score; or TIDC #4: FE/WTRU honesty index (measured with long-term interaction).

In direct WTRU Access to eTMF, the WTRU (for example, the FE 420) can directly reach out to the eTMF using the ServiceID. The ServiceID needs to be included in ExternalServiceID-TINFO. Further, the FE could discover and know ServiceID from the eTMF. The eTMF can then reference the ExternalServiceID-TINFO to provide the pre-negotiated TIDC without requiring the involvement of the iTMF.

Such an approach may have benefits, including convenience, reduced overhead and faster trust building. Convenience may result because this mapping allows the WTRU to interact directly with the eTMF, which speeds up the trust-building process. Reduced overhead may result because this mapping reduces the communication burden on the iTMF, as the eTMF can autonomously provide pre-negotiated TIDC. Faster trust building may result because the WTRU can request TINFO directly from the eTMF without waiting for the iTMF to act as an intermediary.

The Sub-step 402.3 may further include a TrustConfiguration. The TMFs could also configure or define additional operational parameters that govern how TINFO are processed, calculated, and exchanged between the iTMF and eTMF. The key parameters may be as follows: ScaleRange, which indicates the range of the scale being int or float; TimeWindow, which establishes the time range over which the trust calculation is applicable, and Mode, which specifies the trust index mode, which could be Average, Median, Max, or Min over TimeWindow. A summary of trust collaboration details is given in Table 2, below.

TABLE 2
Summary of Trust Collaboration Details between iTMF and eTMFs

| | | Shared/ |
|---|---|---|
| Parameter | Description | Local |
| ProvidedTrustIndicator | List of trust indicators each party | Shared |
| | (for example, an iTMF and/or an | between |
| | eTMF) can provide. | iTMF |
| | | and |
| | | eTMFs |
| ServiceID-TINFO | Mapping of ServiceIDs to TINFO that | Local |
| | is required for trust evaluation for | (not |
| | approving any access request to the | shared) |
| | service denoted by a ServiceID. | |
| ExternalServiceID- | Mapping of ServiceIDs to TINFO that | Shared |
| TINFO | is required for trust evaluation for | between |
| | approving any access request to the | iTMF |
| | service denoted by a ServiceID. | and |
| | | eTMFs |
| TrustConfiguration | Configurable parameters for trust | Shared |
| | evaluation (for example, time | between |
| | windows, mode, translation, etc.). | iTMF |
| | | and |
| | | eTMFs |

The Sub-step 402.4 may include creating an eTMF Profile. After confirming the trust details, the trust collaboration between the iTMF and the eTMF is established. In a dynamic trust environment, one TMF trusting another TMF could change over time. So, regardless of the mutual-trust or collaboration outcome, the iTMF may create and maintain a profile for each eTMF, referred to as an eTMFProfile. The eTMFProfile may include one or more of: an eTMFProfileID, the identifier of this eTMF profile; an eTMFID, the identifier of the eTMF, the same as ExternalTMFID in Step 401; a TrustStatus, which indicates whether and how is this eTMF being trusted, where TrustStatus=“Trusted as a TP” (indicates that this eTMF is a TP and this eTMF may be trusted via business agreements with iTMF), TrustStatus=“Trusted relying on a third-party TP” (indicates that this eTMF is trusted through endorsement by the third-party TP; in this case, the identifier of the third-party TP may be included); and TrustStatus=“None” (indicate that this eTMF is not trusted, and the following parameters may not be applicable); a ProvidedTrustIndicator, which may be the same as in Step 402.3 as sent by the eTMF to the iTMF; a ServiceID-TINFO, the same as ServiceID-TINFO in Sub-step 402.3; an ExternalServiceID-TINFO, the same as ExternalServiceID-TINFO in Sub-step 402.3; a TrustConfiguration, the same as TrustConfiguration in Sub-step 402.3; an AssociatedFEs, which indicates the FEs for which a specific eTMF can determine their trust (this parameter may: be updated whenever an FE performs actions such as FE trust registration; may include the FE that sent the trust registration request in Step 401; and may contain a list of identifiers of those FEs and/or a list of identifiers of their FE profiles); and a Waiting TimeEstimation, based on interaction with this eTMF, the iTMF may estimate the waiting time for external trust request. The iTMF can leverage this parameter to choose better eTMFs (for example, with smaller Waiting TimeEstimation) to which the iTMF may send urgent external trust info requests in the future.

In a Step 403, the iTMF 440 may create an FE profile for the requestor FE 420. Once the FE profile is created, the iTMF 440 can associate the FE profile with eTMF profiles and choose to store them either locally or in one or more other NFs (for example, a UDR) within its internal domain. An FEPofile may include one or more of: a FEProfileID, the identifier of this FE profile; an FEID, the identifier of the requestor FE; an ExternalIDMapping, a mapping pair between ExternalTMFID and FEExternalID, which can be expressed in the format {ExternalTMFID: FEExternalID}, where this parameter also helps to identify eTMFProfile associated with a FE for more specifics (FEExternalID is the external identifier of FE in the external domain which the eTMF as denoted by ExternalTMFID belongs to), and where this parameter may contain multiple mapping pairs (ExternalTMFID component may contain the identifier of the eTMF profile of the corresponding eTMF); an FEContext, the same as FEContext in Step 401; a DefaultTMF, same as DefaultTMF in Step 401; and a TrustedEDLst, a list of TMFs in EDLst, trusted by the iTMF as a result of Step 402, which may be utilized for future TIDX generation for the FE 420.

In a Step 404, the iTMF 440 may generate an FE trust registration response and send it back to the FE 420. The response may not only confirm registration and but also specify the trusted eTMFs for TIDX generation. This response may contain the following parameters: an FEProfileID, the identifier of the FEProfile being created in Step 403 or indicated in Step 401; a TrustedEDLst, as determined in Step 402 and included in the FEProfile created in Step 403; an iTMFPublicKey, the public key of the iTMF 440 which the FE 420 may use to verify iTMF signature in future; and an eTMFProfileIDLst, the list of eTMF profile identifiers being created in Step 403 and being associated with the FEProfile.

In a Step 405, the requestor FE 420 can now interact with NFs to access services provided by internal domain. In general, the requestor FE 420 sends a request, which may contain “ServiceID” of the requested service, to an NF 430. Then, the NF 430 will contact the iTMF 440 to get the latest trust index of the requestor FE 420 about the service as denoted by “ServiceID.” If “ServiceID” is not contained in the request from the requestor FE 420, the NF 430 may determine a “ServiceID” and send “ServiceID” to the iTMF 440. Then, the NF 430 authenticates the requestor FE 420 based on its trust index being obtained from the iTMF 440 and provides requested services to the requestor FE 420.

At any time after/during Step 405 or after Step 404, the requestor FE 420 may issue an FE profile operation request, in a Step 406 to retrieve/update/delete its FE profile (and/or FE profiles of other FEs) maintained at the iTMF 440. Then, the iTMF 440 may send an FE profile operation response to the requestor FE 420. For example, when the requestor FE 420 starts to interact with a new external domain and the new external domain has a new eTMF 480 that can provide trust information of the requestor FE 420 more efficiently, the requestor FE 420 indicates this new eTMF 480 to the iTMF 440 by updating its FE profile. In another example, when the requestor FE 420 stops interacting with an existing external domain (and an existing eTMF) or the existing eTMF shows degraded performance, the requestor FE 420 may remove this existing eTMF from the iTMF 440 by updating its FE profile too. The trust evaluation done by the iTMF 440 for the requestor FE 420 may become unexpected or untrustworthy to the requestor FE 420. In this case, the requestor FE 420 may request to remove its FE profile from the iTMF 440.

Specifically, the FE profile operation request may be a query request, an update request, or a delete request. This request may indicate one or more of the following parameters: an FEID, the identifier of the requestor FE; an FEProfileID, the identifier of the FE profile to be retrieved, updated, or deleted; a FEProfileContentToBeRemoved, the current content of the FE Profile to be removed; and a NewFEProfileContent, the new content of the FE Profile to be updated to. NewFEProfileContent and/or FEProfileContentToBeRemoved is only needed when the request is for updating an existing FE profile. NewFEProfileContent may contain a new value of any parameters included in Step 401.

The FE profile operation response is a response to a retrieve request, an update request, or a delete request. For a retrieve request, the FE profile operation response may contain the content of the partial or the whole content of the corresponding FE Profile. For an update request, the FE profile operation response may just indicate if the requested updates have been successfully performed. If NewFEPRofileContent contains a new eTMF, the iTMF 440 may repeat Step 402 to establish the trust collaboration with the new TMF. Then, the FE profile operation response may additionally contain the same information as in Step 404.

For a delete request, the FE profile operation response may just indicate if the requested deletion has been successfully performed. As a result of performing the requested deletion (for example, including the removal of some existing eTMFs), the iTMF 440 may remove the association between the deleted FE profile and any existing eTMF profile (for example, to remove the corresponding FE from AssociatedFEs of the existing eTMF profile).

An example of cross-domain trust collaboration establishment triggers FE trust registration is provided in the following. In an example, an FE may be preconfigured with one or multiple eTMFs, with their identifiers and/or contact information. The FE receives an FE trust registration request notification from a first network node. In example, the network node may be an iTMF. Further, the FE trust registration request notification may contain the contact information of the first network node.

Further, the FE sends an FE trust registration request to the first network node. The FE trust registration request may contain the identifier or contact information of one or multiple eTMFs. Further, the FE trust registration request may contain the FE's internal identifier. Additionally or alternatively, the FE trust registration request may contain the FE's external identifier.

Also, the FE receives an FE trust registration response from the first network node. The FE trust registration response may contain the identifier of an FE profile created by the first network node for the FE. Additionally or alternatively, the FE trust registration response may contain the identifier of one or multiple eTMFs, which the first network node has built trust collaboration relationships with. Additionally or alternatively, the FE trust registration response may contain the identifier of one or multiple eTMF profiles of the trusted eTMFs created by the first network node. Additionally or alternatively, the FE trust registration response may contain the association of the FE profile and eTMF profiles. Additionally or alternatively, the FE trust registration response may contain the identifier of the first network node, such as the iTMF.

Moreover, the FE may send an FE trust registration completion notification to one or multiple eTMFs selected from the FE trust registration response. The FE trust registration completion notification may contain the identifier of the first network node, such as the iTMF. Additionally or alternatively, the FE trust registration completion notification may contain the identifier of the eTMF. Additionally or alternatively, the FE trust registration completion notification may contain the FE's external identifier.

In an example, the FE may be a WTRU. In another example, the FE may be on a WTRU.

FIG. 6 is a signaling diagram illustrating an example of FE trust registration triggered by cross-domain trust collaboration establishment. An example shown in signaling diagram 600 covers the scenario where iTMFs and eTMFs may proactively build cross-domain trust collaboration between them for specific sets of FEs and/or specific types of services/requests, in advance. FIG. 6 includes the following logic entities or actors. An FE 620 is a function entity in the internal domain, which may be a WTRU or an FE on WTRU. This FE 620 is a requestor FE or a registering FE. The FE 620 may engage with several external AFs integrated with an eTMF or other PLMN or other external domains, which can assist in TIDX generation to establish mutual trust relationships with the other FEs. An iTMF 640 is the TMF in the internal domain (for example, a 6G serving network). eTMFs 680 are TMFs in external domains (for example, a DN, 6G home network of FE such as a PLMN or an NPN).

A Step 601 may be similar to Step 402 of FIG. 4. As a result of trust collaboration establishment between the iTMF 640 and eTMFs 680, the iTMF 640 has created an eTMF profile for each trusted eTMF and vice versa. Also, the iTMF 640 may know a list of FEs for which a trusted eTMF can provide their trust information (for example, via AssociatedFEs of an eTMFProfile). For example, the eTMF 680 may have been interacting with a number of FEs including the FE 620 in FIG. 6. Further, the eTMF 680 may share the list of those FEs via AssociatedFEs with the iTMF 640 as a part of trust collaboration establishment. Step 601 may be repeated multiple times (for example, one time each for a different eTMF).

The iTMF 640 may proactively perform Step 601 to build cross-domain trust collaboration with one or multiple eTMFs 680 for specific sets of multiple FEs and/or specific types of multiple services/requests. In this case, the iTMF 640 and eTMFs 680 may exchange/indicate/notify the list of identifiers of those FEs/services/requests and indicate/agree that the purpose of established trust collaboration is collaborative trust evaluation of those FEs/services/requests.

In a Step 602, by checking the parameter eTMFProfile: AssociatedFEs against the list of registered FEs (for example, FEs may have registered with the iTMF using the procedure in FIG. 4), the iTMF 640 is able to identify a subset of FEs of eTMFProfile: AssociatedFEs which are not registered to the iTMF 640. For those unregistered FEs, the iTMF 640 may be able to find their identifiers within its internal domain (for example, 3GPP identifiers within a PLMN or NPN) consulting other NFs (for example, a UDM, UDR, and the like) based on the external identifier contained in AssociatedFEs. For each unregistered FE, the iTMF 640 may send an FE trust registration notification to each of those unregistered FEs and trigger them to register with the iTMF 640 (for example, via steps 603-605). Without registering with the iTMF 640, an FE cannot leverage trust evaluation services provided by the iTMF 640. Such registration notification also makes an FE be aware that its interactions with the corresponding eTMF will impact its trust information at the eTMF but also may impact its trust information at the iTMF 640 since the eTMF might share the FE's trust information to the iTMF 640. This FE trust registration notification may contain one or more of the following parameters: an eTMFProfileIDList, a list of identifiers of the corresponding eTMF profiles which the FE 620 is associated with; an ExternalTMFID, the identifier of the eTMF that the eTMF profile as denoted by eTMFProfileID; an FEExternalID, the identifier of the FE within the external domain covered by the eTMF; an iTMFID, the identifier of the iTMF 640, and an iTMFCredential, the credential of the iTMF 640.

In a Step 603, after receiving the FE trust registration notification, the FE 620 will check if it has been associated with the corresponding eTMF as denoted by ExternalTMFID. If it has not been associated the eTMF, the FE 620 may not perform FE trust registration and this procedure ends. Additionally, the FE 620 also may check if it is willing to do FE trust registration with the iTMF 640, for example, by checking and validating an iTMFCredential. If validation fails, the FE 620 may not perform FE trust registration and this procedure ends.

After the notification is validated, the FE 620 creates and sends an FE trust registration request to the iTMF 640. This request is similar to and may contain the same set of parameters as that in Step 401 of FIG. 4. In this request, the FE may include ExternalTMFID as received from Step 602 and may also include information of additional eTMFs associated with the FE 620, including their eTMFProfileID, ExternalTMFID, and the FE's FEExternalID in the EDLst within the FE trust registration request.

An alternative or a complementary approach for Steps 602 and 603 is described herein. The FE 620 has already registered with the iTMF 640 before Step 601, but this iTMF 640 had limited capability in trust evaluation and/or other trust-related support. For example, this iTMF 640 cannot provide valuable trust evaluation service to the FE 620. As result, the FE 620 temporarily decided not to use it and informed this decision to the iTMF 640.

Now this iTMF 640 has established a new collaboration with eTMF as a result of Step 601. Thus, this iTMF 640 can provide better trust evaluation service to the FE 620. As a result, this iTMF 640 may send a trust service notification to the FE 620 to ask it to resume its trust registration with this iTMF 640. This trust service notification may contain the identifier of the iTMF 640, the identifier of the FE 620, the identifier of the previously trust registration that the FE 620 has done with the iTMF 640, the purpose of this trust service notification (for example, resume previous registration, request the FE 620 to do a new registration request), some parameters contained in Step 603, and so forth.

After receiving the trust service notification, the FE 620 may simply regard and determine the iTMF 640 as the one to provide expected trust evaluation service to the FE 620, or the FE 620 may initiate a new trust registration with the iTMF 640, depending on “the purpose of this notification” as contained in the received trust service notification.

In a Step 604, the iTMF 640 may create and associate an FE profile with eTMF profiles. The details of Step 604 may be similar to those in Step 403 of FIG. 4.

Further, Step 605 may be similar to Step 404 of FIG. 4. In this FE trust registration response, the iTMF 640 may include an indication or flag, which triggers the FE 620 to perform Step 606 so that the eTMF knows that the iTMF 640 may start to request trust information of the requestor FE 620 from the eTMF anytime, and the eTMF can make itself be ready for that.

In Step 606, the FE 620 may send an FE trust registration completion notification to the eTMF to inform the eTMF that it has been successfully registered to the iTMF 640. After receiving this notification, the eTMF knows that incoming requests from the iTMF 640 are possible anytime, and it may adjust its local resources (for example, computing) to be ready for serving the iTMF's requests. This notification may contain the following parameters: an FEExternalID, the identifier of the FE 620 within the external domain covered by the eTMF; an FEProfileID, the identifier of the FE profile that the iTMF 640 created for the FE 620 in Step 604, and an iTMFID, the identifier of the iTMF 640. Additionally or alternatively, the iTMF 640 may also send the same notification in Step 606 to the eTMF.

Step 607 is similar to Step 405 of FIG. 4. For example, the requestor FE 620 can now interact with NFs, such as NF 630, to access services provided by internal domain. Further, the NF 630 may also contact the iTMF 640 to get the latest trust index of the requestor FE 620, as described in Step 405 of FIG. 4.

Step 608 is similar to Step 406 of FIG. 4. For example, the requestor FE 620 may issue an FE profile operation request, as in Step 406 of FIG. 4, to retrieve/update/delete its FE profile (and/or FE profiles of other FEs) maintained at the iTMF 640. Further actions in the FE profile operation may be undertaken, as described in Step 406 of FIG. 4.

In an example, an FE receives a trust registration request notification from a first network node, including contact information of the first network node. The FE sends an FE trust registration request to the first network node, including contact information of eTMFs, and an identifier of the FE. Further, the FE receives an FE trust registration response from the first network node, including one or more of: an identifier of an FE profile for the FE, an identifier of the eTMFs, an identifier of eTMF profiles, an association of the FE profile and the eTMF profiles, or an identifier of the first network node. Moreover, the FE sends an FE trust registration completion notification to a selected eTMF of the eTMFs, based on the FE trust registration response. In an example, the FE trust registration completion notification includes the identifier of the first network node, an identifier of the selected eTMF, and the identifier of the FE.

Additionally or alternatively, an iTMF is in the first network node. Additionally or alternatively, the iTMF operates within a current PLMN for the WTRU. Additionally or alternatively, the one or more eTMFs operate outside of the current PLMN for the WTRU.

Additionally or alternatively, the FE trust registration request further includes an identifier for each of the one or more eTMFs. Additionally or alternatively, the identifier of the FE is an internal identifier. Additionally or alternatively, the identifier of the FE is an external identifier.

Additionally or alternatively, the FE profile for the FE is a profile created by the first network node for the FE. Additionally or alternatively, the one or more eTMFs have trust collaboration relationships with the first network node. Additionally or alternatively, the one or more eTMF profiles are profiles of trusted eTMFs created by the first network node.

Additionally or alternatively, the FE is a wireless transmit/receive unit (WTRU). Additionally or alternatively, the selected eTMF is in a second network node.

FIG. 7 is a signaling diagram illustrating an example of trust registration triggering cross-domain trust collaboration establishment. An example in signaling diagram outlines the procedure of FE trust registration followed by cross-domain trust collaboration establishment. FIG. 7 includes the following logic entities or actors. An FE 720 is a function entity in internal domain, which may be WTRU or an FE on WTRU. This FE 720 is a requestor FE or a registering FE. The FE 720 may engage with several external AFs integrated with an eTMF or other PLMN or other external domains, which can assist in TIDX generation to establish mutual trust relationships with other FEs. An iTMF 740 is an TMF in the internal domain (for example, a 6G serving network). Further, eTMFs 780 are TMFs in the external domains (for example, a DN, 6G home network of FE such as a PLMN or an NPN).

In a Step 701, the FE 720 may send an FE trust registration request to iTMF 740. The details of Step 701 are similar to those in Step 401 in FIG. 4.

Further, a Step 702 is similar to Step 403 in FIG. 4. However, in Step 702, the iTMF 740 may only create an FE profile without creating any eTMF profile since “trust collaboration establishment” with eTMFs 780 has not been performed. Additionally or alternatively, the iTMF 740 may create a temporary eTMF profile for each eTMF indicated by the FE 720 or selected for the FE 720. In other words, the FE 720 indicates some eTMFs to the iTMF 740. Further, the iTMF 740 may select some eTMFs from the ones indicated by the FE 720 or other eTMFs the iTMF 740 may have maintained locally. The iTMF 740 may create a temporary eTMF profile for each selected eTMF and associate the created FE profile with corresponding temporary eTMF profiles. Temporary eTMF profiles may be changed to final eTMF profiles after Step 704 and/or during Step 705.

In a Step 703, the iTMF 740 may send an FE trust registration response to the FE 720. The details of Step 703 are similar to those in Step 404 of FIG. 4. In Step 703, the iTMF 740 may inform the FE 720 that: 1) trust collaboration establishment with the selected specific eTMFs in Step 702 is pending and will be done in Step 704; and 2) after trust collaboration establishment, the iTMF 740 will send a trust collaboration establishment notification to the FE 720 in Step 706.

Step 704 is similar to Step 402 of FIG. 4. After trust collaboration establishment with an eTMF, the iTMF 740 will create an eTMF profile or update the temporary eTMF profile for each trusted eTMF and vice versa.

Step 705 is similar to Step 403 of FIG. 4. In this step, the iTMF 740 associates the FE profile created in Step 702 to the eTMF profile created or updated in Step 704.

In a Step 706, the iTMF 740 may send a trust collaboration establishment notification (e.g., containing an ExternalTMFID) to the FE 720 to inform the FE 720 that: 1) the trust collaboration between the iTMF 740 and an eTMF has not been established; 2) in future, the eTMF may be able to provide the FE's trust information to the iTMF 740 as needed. This notification may be sent to the FE 720 multiple times; each notification is for a different eTMF that the iTMF 740 has built trust collaboration with. In this case, an ExternalTMFID in this notification only contains the identifier of one eTMF. Additionally or alternatively, one such notification may contain a list of identifiers of multiple or all eTMFs that the iTMF 740 has established trust collaboration with in Step 704.

This notification may contain the following parameters: an FEExternalID, the identifier of the FE within the external domain covered by the eTMF; an FEInternalID, the identifier of the FE within the internal domain covered by the iTMF; an iTMFID, the identifier of the iTMF 740; and an ExternalTMFID, the identifier of a single eTMF or a list of identifiers of eTMFs that the iTMF 740 has established trust collaboration with in Step 704. In an example, the eTMF may send the same notification in Step 706 to the FE 720 directly.

Step 707 may be similar to Step 405 of FIG. 4. Further, Step 708 may be similar to Step 406 of FIG. 4.

FIG. 8 a signaling diagram illustrating an example of cross-domain trust collaboration establishment. Before an iTMF can invoke an eTMF to share TINFO of a WTRU, a trust collaboration must first be established between the iTMF and the eTMF. The relationship between internal and external entities can be categorized into two scenarios, as follows.

In a WN-with-WN scenario, a wireless network (WN) may be a PLMN, NPN, CPN, PIN, WiFi, and so forth. The trust collaboration between two PLMNs (for example, an eTMF is within a PLMN) can be established as shown in Step 801 of FIG. 8, where both parties build a trust relationship based on business agreements. If no agreement has been reached between the two PLMNs, the trust relationship can also be completed by applying WN-with-AF procedures (for example, Steps 802-810).

In a WN-with-AF scenario, the WN may be a PLMN, NPN, CPN, PIN, WiFi, and so forth. The process for establishing a trust relationship between a PLMN and an AF/ASP (for example, an eTMF is an AF) is depicted in Steps 802-807 in FIG. 8, where specific procedures are followed to ensure secure and collaborative trust interactions.

Signaling diagram 800 illustrates the procedure for establishing trust collaboration between a PLMN and an AF/ASP, facilitated by a TP 860. The TP 860 is a neutral, trusted intermediary that is mutually trusted by both an iTMF 840 and an eTMF 880. The role of the TP 860 is to bridge the trust gap between the two parties (for example, the iTMF 840 and the eTMF 880 as an AF) by transferring the trust of one party to the other.

FIG. 8 includes the following logic entities or actors. The iTMF 840 is the TMF in the serving network of WTRU, such as a 6G PLMN or an NPN. The one or more eTMFs 880 are the one or more TMFs in a non-serving network, and could be an AF in a DN and/or a TMF in the home network of WTRU. The TP 860 is a trusted third-party entity that is mutually trusted by both the iTMF 840 and the eTMF 880. The TP 860 plays a key role in bridging the trust gap between the two parties by facilitating trust establishment and verification. An example herein assumes both the iTMF 840 and the eTMF 880 have been configured or provisioned with the identifier of one or multiple TPs. An NEF is a network exposure function in the serving network of WTRU. The NEF serves as a bridge for WN-with-AF communication. Note that NEF in 6GS may have a different name or embedded in a new 6G NF. An SEPP is a security edge protection proxy connecting the serving wireless network and the home wireless network. The SEPP handles WN-with-WN communication. Note that the SEPP in 6GS may have a different name or embedded in a new 6G NF. In the NEF/SEPP 850 in the cross-domain concept, both scenarios are accounted for, and NEF and SEPP are collectively referred to as NEF/SEPP 850.

As an example, the TP 860 may enable bidirectional trust collaboration establishment as follows. The eTMF 880 trusts the iTMF 840 in an example. For example, an iTMF belongs to a wireless provider (for example, an MNO). In this case, the TP 860 could be a certification authority (CA), verifying the digital certificate of the iTMF 840 and ensuring its authenticity. By validating the iTMF's certificate, the TP 860 enables an eTMF 880 to recognize and trust the iTMF 840. The eTMF 880 can trust an iTMF once the new eTMF verifies that a message is genuinely from that iTMF with the aid of the TP 860.

Besides using the iTMF's certificate, the eTMF could additionally apply “remote attestation” (for example, to check the iTMF's executed code) to strengthen the trust collaboration. The failure of either certificate checking or remote attestation may lead to unsuccessful establishment of trust collaboration. This approach (for example, the combination of checking certificate and remote attestation) could be applied for an iTMF trusts eTMF scenario.

The iTMF trust the eTMF, in another example. For example, an iTMF in a wireless provider (for example, an MNO) trusts an eTMF through approaches such as remote attestation. This process involves verifying the integrity of the eTMF's executed code and build environment to check for any signs of tampering or intrusion. In this case, the TP 860 serves as a verifier with the capability to detect kernel tampering or potential intrusions on the eTMF. Once the attestation process confirms the integrity of the eTMF, the iTMF can establish trust in the new eTMF.

The iTMF may also verify the eTMF's certificate before or after performing remote attestation. The failure of either certificate checking or remote attestation may lead to unsuccessful establishment of trust collaboration. This approach (for example, the combination of remote attestation and checking certificate) could also be applied for an eTMF trusts iTMF scenario.

The approach described above for “eTMF Trusts iTMF” can be applied to “iTMF Trusts eTMF.” Also, the approach described above for “iTMF Trusts eTMF” can be applied to “eTMF Trusts iTMF”.

Through the use of a TP, the trust relationship between the iTMF and eTMF can be established efficiently. The TP ensures that trust is built on verifiable evidence, such as certificate validation and integrity attestation, enhancing the security and reliability of cross-domain trust collaboration.

Building trust relationship could also be recursive. Once the eTMF is trusted by the iTMF, the iTMF can evaluate whether the eTMF qualifies to become a new TP capable of facilitating trust with other domains or eTMFs. The criteria for promoting an eTMF to a TP may include factors such as the eTMF being validated by multiple existing TPs and achieving a high TIDX. This approach strengthens the overall trust of a 6G network and expands the ecosystem of trusted entities across domains.

The following are the detailed procedures for FIG. 8. In a Step 801, trust relationship has been established between the iTMF 840 and the TP 860, between the TP 860 and the eTMF 880, and between the iTMF 840 and the eTMF 880. The trust relationship can be done with business agreements; or technology-based approaches (for example remote attestation, blockchain and distributed ledgers technology, and trust collaboration in FIG. 4).

In a Step 802, the iTMF 840 configures an NEF (applied to WN-with-AF) or SEPP (applied to WN-with-WN) to forward future trust relationship establishment request from the eTMF 880 to the iTMF 840. The configuration from the iTMF to NEF/SEPP could attach one or more of the following parameters. A TargetEndpoint is the target endpoint address (for example, URL or FDQN) where the trust relationship establishment request is directed. If a request is sent to this URL, it is considered a trust request and must comply with the constraints defined by the following parameters. A ForwardingEndpoint is the destination endpoint address (for example, URL or FQDN) where the trust relationship establishment requests should be forwarded. An Action is the type of action for the request, such as create, update, or delete a trust relationship establishment request. A ContentFormat specifies the required content format for the trust relationship establishment request message, including the required fields and data format (for example, JavaScript Object Notation (JSON), Extensible Markup Language (XML)).

In a Step 803, the eTMF 880 decides to initiate the trust collaboration establishment with one or multiple iTMFs. The eTMF 880 can make this decision for various motivations, including: a user-driven motivation or a proactive trust collaboration.

In a user-driven motivation, existing users of Domain B (where the eTMF 880 resides) may request or influence the eTMF 880 to initiate a trust collaboration to facilitate seamless cross-domain trust collaboration interactions. In an example, the iTMF 840 is in a visited PLMN of a WTRU and the eTMF 880 is the home PLMN of the WTRU. During WTRU registration with the visited PLMN, the home network gets contacted and notified. Then, the WTRU may signal or suggest the eTMF 880 in the home PLMN to contact the visited PLMN to establish trust collaboration with the iTMF 840 in the visited PLMN. There are two approaches that the WTRU may send the signal or message to the eTMF 880, as follow. In approach 1, the WTRU uses the control plane. For example, the WTRU may send the signal to the visited network using the control plane, which will then forward the signal or message to the eTMF 880 in the home PLMN. In approach 2, the WTRU uses the data plane. When there is direct Service-Based Interface (SBI) between the WTRU and the eTMF 880 (for example, in future 6G networks), the WTRU may send the signal or message to the eTMF 880 directly over the SBI.

In proactive trust collaboration: The eTMF 880 proactively establishes trust collaborations in anticipation of potential incoming external trust demands, ensuring it is prepared to support future service requests from other domains (for example, iTMFs).

In a Step 804, the new eTMF sends a trust collaboration request to iTMF 840. This request is forwarded via the NEF in a PLMN-to-AF scenario or via the SEPP in a PLMN-to-PLMN scenario. This request may include but not limited to the following parameters/fields. An eTMFID is the identifier of the new eTMF. An eTMFCredential is the credential of the new eTMF, which may be a certificate, token, or other authentication proof that can be used to verify the identity of the new eTMF. An UEExternalIDList is a list of external identifiers of WTRUs that are relevant for the trust relationship establishment. If the new eTMF knows 3GPP identifiers of these WTRUs, this parameter may also contain their 3GPP identifiers. This list may be in one or more of the following forms: a Whitelist, a Blacklist, or WTRUs Accessing Both Domains. The Whitelist is the whitelist WTRUs/users that the eTMF intends to support or collaborate on with the iTMF. The Blacklist is the blacklist WTRUs/users that the eTMF does not intend to support. The WTRUs Accessing Both Domains is list of WTRUs/users that access services from both domains, which the iTMF and eTMF represent respectively. Further, a TPList is a list of TPs proposed by the eTMF. These TPs are entities that the eTMF assumes may be trusted by the iTMF. Since the iTMF may not trust every TP in the list, the eTMF may intend to include multiple candidates to increase its request accepted rate.

The NEF/SEPP 850 takes some validation steps to ensure only authorized and properly formatted requests are forwarded. For example, in an Address Validation, the system verifies if the message is sent to a specific pre-configured address (for example, a URL or an endpoint address). In a Content Format Validation, the system checks if the message content format follows a pre-configured structure. This may involve checking the request type, data format (for example, JSON, XML), or specific required fields (like eTMFID, eTMFCredential, UEExternalIDList, and TPList).

Once both validation steps are successfully met, the NEF/SEPP 850 forwards the trust relationship establishment request to the iTMF 840 for processing. This approach ensures only valid, properly formatted, and authorized requests are passed to the iTMF 840, enhancing security and reliability.

In a Step 805, the iTMF 840 verifies eTMF credential (e.g., with the TP 860), which is trusted both by the iTMF 840 and the eTMF 880. This is a high-level step description. The actual steps could be many more, and with eTMF 880 included. For example, if using remote attestation, the iTMF 840 will send a challenge to the eTMF 880 to be integrated into the hash to prevent replay attack. Then the eTMF 880 can submit its evidence (for example, a hashed kernel with a challenge and a hashed compiling environment with challenge) to the iTMF 840, where the evidence is forwarded to the TP 860 for verification. The TP 860 validates the integrity of the eTMF's evidence and sends the verification result back to the iTMF 840.

In a Step 806, the iTMF 840 may admit the eTMF 880 as a trusted eTMF for subsequent trust negotiations. The iTMF 840 sends a trust collaboration response to the eTMF 880. This response may contain the identifier of the TP 860 with which the iTMF 840 verified the eTMF 880 in Step 805, the verification result from Step 805 (for example, a success or failure), a time period that the iTMF 840 may determine for maintaining the built trust relationship with the eTMF 880. This establishes a formal trust relationship between the iTMF 840 and the eTMF 880, allowing further interactions between the two entities.

In a Step 807, the iTMF 840 and the eTMF 880 exchange their available Trust Indicators (TIDCs) with each other (e.g., ProvidedTrustIndicator). As used in example and embodiments here, TIDCs represent a set of trust metrics or key performance indicators (KPIs) that measure trust of a WTRU from multiple perspectives, such as but not limited to connectivity, reliability, and behavioral analysis. The parameters need to be passed. For example, a ProvidedTrustIndicator may be the same as the ProvidedTrustIndicator in Step 402 of FIG. 4.

In a Step 808, both the iTMF 840 and the eTMF 880 establish a mapping between ServiceIDs and the trust indicators (TIDCs) provided by each other (for example, the ProvidedTrustIndicator as described in Step 402 of FIG. 4) and store the established mapping (for example, a ServiceID-TINFO as described in Step 402 of FIG. 4) locally. For instance, in the context of an FL client use case, the iTMF 840 needs to determine if a WTRU is trustworthy as an FL client. In this case, the relevant indicators could include: TIDC #1: WTRU connectivity (This indicator can be measured directly by the iTMF); TIDC #2: WTRU's trustworthiness as an FL client (this indicator must or can be provided by the eTMF); and TIDC #3: WTRU's training data diversity (that indicator can be provided by the eTMF).

When the iTMF 840 receives a request to assess the trustworthiness of a WTRU as an FL client, it can map this request to the required indicators. Since the iTMF 840 can obtain TIDC #1 directly within the domain, it only needs to request TIDC #2 and/or TIDC #3 from the eTMF 880.

In a Step 809, the iTMF 840 and the eTMF 880 may also exchange the ServiceID-TIDC mappings (for example, ServiceID-TINFO) with each other, which may bring two benefits. In a first benefit, the exchange allows a concise message. As the previous example, the iTMF 840 requires the following indicators for trust assessment: TIDC #2: WTRU's trustworthiness as an FL client (from Step 808); and TIDC #3: WTRU's training data diversity. Accordingly, instead of requesting these indicators, the iTMF 840 can associate both indicators with a single ServiceID. By sending this ServiceID in an external trust information request, the eTMF 880 knows that the iTMF 840 is requesting both TIDC #2 and TIDC #3. This approach reduces communication overhead and simplifies trust information request management between the iTMF 840 and the eTMF 880.

In a second benefit, the exchange allows inbound trust proof (for example, the WTRU prove its trustworthiness from the eTMF 880. When a WTRU request the eTMF 880 to provide its trust information for a certain service, it may not know the mapping between ServiceID and TIDC. With mapping known by the eTMF 880, this inbound trust proof is possible to be provided by the eTMF 880.

After this step, both eTMF 880 and the iTMF 840 may have and store the following parameters: External ServiceID-TINFO (same as External ServiceID-TINFO in Step 402 of FIG. 4), and TrustConfiguration (same as TrustConfiguration in Step 402 in FIG. 4).

In a Step 810, both parties (for example, the iTMF and the eTMF) could summarize above interactions and store the other party's profile for future collaboration. Accordingly, in a Step 810a, the iTMF 840 may create an eTMF profile. Similarly, in a Step 810b, the eTMF 880 may create an iTMF profile. The description here is applied to or added to the eTMF profile on the iTMF 840. But it also applies to the iTMF profile stored on the eTMF 880.

The iTMF 840 may store an eTMFProfile, the profile of an eTMF, which may contain the following parameters. An eTMFProfileID is the identifier of this eTMF profile. An eTMFID is the identifier of the eTMF. A TrustedMode indicates if the eTMF is trusted and how is it trusted. For example, a ‘TrustedMode=SelfAsATP’ applies when the eTMF is a TP. In this case, trust is established via business agreements. Further, a ‘TrustedMode=RelyOnTP’ applies when trust is established with the assistance of a specific TP, and the identifier of the TP is recorded. Also, ‘TrustedMode=None’ applies when the eTMF is not trusted. A ProvidedTrustIndicator is a list of trust indicator can be provided by the eTMF. This information helps the iTMF understand which trust-related metrics or TINFO can be requested from the eTMF. A ServiceID-TINFO is a mapping between ServiceIDs (as defined in the iTMF domain) and the corresponding Trust Indicators. This mapping follows the procedure outlined in Step 808. An External ServiceID-TINFO is a mapping between External ServiceIDs (as defined in the eTMF domain) and the corresponding Trust Indicators. This mapping is based on the approach described in Step 809. A WaitingTimeEstimation is an estimate of the expected response time or processing delay for the eTMF to provide trust indicators or respond to requests. This allows the iTMF to plan for possible delays during external trust request. A TrustConfiguration is a series of parameters regulates the details of the TINFO, including trust value type, trust calculation time frame, trust calculation methods (for example minimum, maximum, and average). An eTMF 880 may store an iTMFProfile, the profile of the iTMF, which may contain the same parameters of the eTMFProfile.

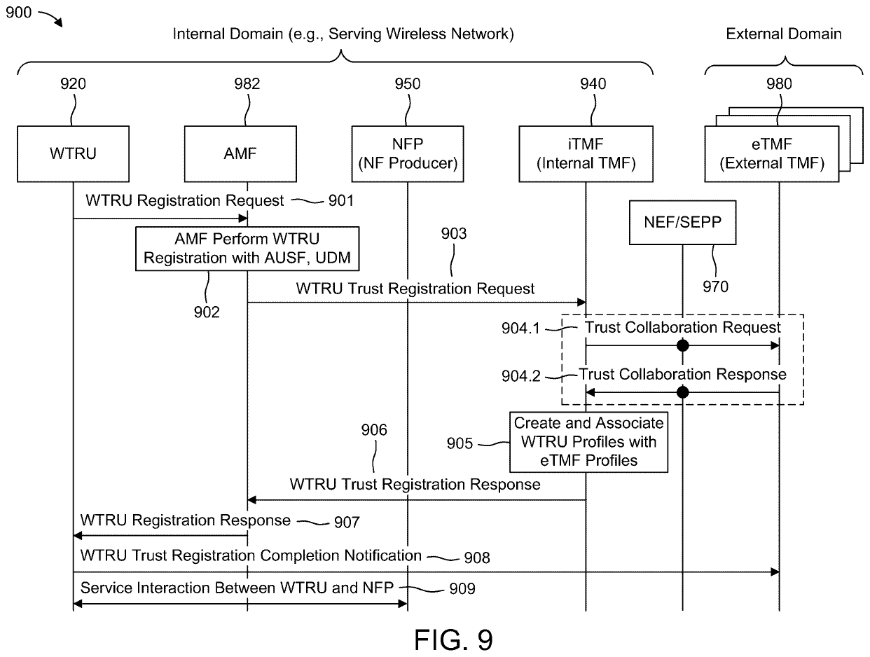

FIG. 9 is a signaling diagram illustrating an example of integrated WTRU registration and WTRU trust registration. Signaling diagram 900 illustrates the enhanced WTRU registration procedure, where a WTRU additionally registers itself to an iTMF via WTRU trust registration and indicates one or multiple eTMFs to the iTMF. The iTMF may also leverage the procedure in FIG. 8 to establish trust collaboration with eTMFs.

FIG. 9 includes the following logic entities or actors. A WTRU 920 is a mobile device and/or a user which requests to access services provided by an NF producer (NFP). An NFP 950 is an NF producer which provides services to the WTRU 920. The NFP 950 may reside in a part of a wireless network (for example, base station, 6G edge network, 6G core network, or a 6G device/WTRU). The NFP 950 could be an AMF. An iTMF 940 is the TMF in the serving wireless network of the WTRU 920, such as a serving 6GS. One or more eTMFs 980 are the TMFs in non-serving wireless network, which could be a DN and/or the home wireless network of the WTRU 920. An AMF 982 is an access and mobility management function in the serving wireless network of WTRU 920. In examples, an AMF in 6GS may have a different name or embedded in a new 6G NF. An NEF is a network exposure function in the serving wireless network of WTRU 920. The NEF serves as a bridge for WN-with-AF communication. In examples, the NEF in 6GS may have a different name or embedded in a new 6G NF. An SEPP is a security edge protection proxy connecting the serving wireless network and the home wireless network. The SEPP handles WN-with-WN communication. In examples, the SEPP in 6GS may have a different name or embedded in a new 6G NF. Moreover, in the cross-domain concept, both scenarios are accounted for, and NEF and SEPP are collectively referred to as NEF/SEPP 970.

The steps in the procedure of FIG. 9 closely align with those outlined in FIG. 4, where the FE 420 in FIG. 4 corresponds to the WTRU 920 and/or NFP 950, as depicted in FIG. 9. Compared to the procedure in FIG. 4, a difference in FIG. 9 is the communication between the WTRU (or FE) and eTMF, which can be done through various ways including: WN-with-WN cross-domain scenario (for example, iTMF in a visited PLMN and eTMF in a home PLMN), where the communication is proxied and forwarded by SEPP (for example, with forwarding policies configured by iTMF) using NAS and/or SBI; or a WN-with-AF cross-domain scenario (for example, iTMF in a serving PLMN and eTMF in a DN), where the communication is forwarded by NEF (for example, with forwarding policies configured by iTMF) and the communication goes through data plane (such as: from eTMF to WTRU: eTMF request consent by pushing an application notification for the WTRU/user to approve; or from WTRU to eTMF: after receiving the notification, the WTRU/user may evaluate it and generate a consent, which may be transmitted to eTMF).

Importantly, the description below for FIG. 9 primarily focuses on the scenario where the NFP 950 requests the TIDX of the WTRU 920 to determine its service accessibility. However, a similar approach (for example the WTRU 920 requests to iTMF 940 for NFP's TIDX) could be applied to the scenario where the WTRU 920 requests the iTMF 940 to verify the legitimacy of the NFP 950. While this second scenario may seem unrealistic under current 5G standards since all NFs are hosted in MNO's domain and can be trusted, it becomes more plausible in a 6G context. In the future 6GS, an NFP could be embedded on a WTRU, and that WTRU might be roaming from a different domain, making it essential to verify the legitimacy of the NFP.

The following description highlights the key parameters exchanged between entities and the differences compared to the solution in FIG. 4. The trust collaboration between the iTMF 940 and the eTMF 980 may have been established using the procedure in FIG. 8.

In a Step 901, the WTRU 920 sends a WTRU registration request to the AMF 982, also indicating a request for the WTRU trust registration with an iTMF 940. This request may include the information outlined in Step 401 of FIG. 4.

In an example, this WTRU registration request may include one or any combination of the following. A UEID is an identifier of the WTRU 920 (for example, a subscription concealed identifier (SUCI), similar to the FEID mentioned in Step 401 of FIG. 4. The UEID may also contain an identifier of the user that uses the WTRU to access the serving network. A UECredential may be similar to FECredential mentioned in Step 401 of FIG. 4. This parameter may contain a user credential. A UEContext may be similar to FEContext mentioned in Step 401 of FIG. 4, which may include one or any combination of the following information: UELocation: physical location of the WTRU, network location of the WTRU, identifier of the point of attachment of the WTRU, or physical region of the WTRU; UEConnectionType: indicates various type of connections (for example, cellular, Wi-Fi, satellite, and so forth) that WTRU may connect to the core network; UEPowerSupplySource: powered by battery, cable, solar, and so forth; and UEType: Being an IoT device, smart phone, vehicle, drone, aviator, and so forth. An EDLst may be similar as EDLst mentioned in Step 401 of FIG. 4, containing a set of mapping pairs between eTMF ID and WTRU's external ID (for example, a generic public subscription identifier (GPSI). An ExternalTMFID is the identifier of an external TMF. This parameter may indicate multiple external TMF IDs. An UEExternalIDLst is a list of the WTRU's identifiers in external domains (for example, GPSIs, Application IDs, user IDs, and so forth). A DefaultTMF may be similar to the DefaultTMF mentioned in Step 401 of FIG. 4. A TrustRegistrationIndicator may be an optional Boolean value, which indicates if the WTRU wants to delegate the AMF to continue WTRU trust registration (for example, step 903) on behalf of the WTRU. If the Boolean value is TRUE, the WTRU delegates the AMF to handle the entity trust registration process and the AMF will initiate step 903 if regular WTRU registration is successful. If the Boolean value is FALSE or this parameter not attached, the AMF may not initiate Step 903 and Steps 903-906 will be skipped.

In a Step 902, the AMF 982 verifies the WTRU's credential by communicating to other NFs, such as an AUSF and UDM. If verification fails, the AMF 982 proceeds to Step 907; otherwise, the AMF 982 continues with the subsequent steps. If the serving network (for example, with some preconfigured policies) does not allow “WTRU trust registration,” Steps 903-906 may be skipped even if WTRU 920 has requested it in Step 901.

In a Step 903, the AMF 982 performs WTRU trust registration, on behalf of the WTRU 920, by sending a WTRU trust registration request to the iTMF 940. This request may provide or contain the details of the WTRU's associated external domains and eTMFs to the iTMF. The AMF 982 may have been provisioned with the address of the iTMF 940; otherwise, the AMF 982 may discover an iTMF from NRF or other NFs. The AMF 982 may select an iTMF for the WTRU 920 and/or look up the iTMF from WTRU subscription data. Most of the parameters (for example, EDLst) received in Step 901 may be forwarded in this step. If the AMF 982 experiences a prolonged wait or anticipates a delay in receiving the iTMF's response or based on other rules/policies/conditions, the AMF 982 may insert an additional step between Step 902 and Step 903 by notifying the WTRU 920 of the regular WTRU registration result as determined in Step 902. If Step 901 contains user IDs and user credentials, both user IDs and user credentials may be contained in Step 903.

In a Step 904, with Sub-steps 904.1 and 904.2, the iTMF 940 may identify some new eTMF IDs which have no corresponding eTMF profile on the iTMF 940. The iTMF 940 may actively (re) establish their trust collaboration using the procedures in FIG. 8; as a result, Step 904 may be skipped.

In Sub-step 904.1, the iTMF 940 sends the trust collaboration request to an eTMF. In this request, the iTMF 940 indicates this WTRU 920 is currently accessing service in both domains, wrapped in UEExternalIDLst.

In Sub-step 904.2, the eTMF sends trust collaboration response to the iTMF 940. Moreover, Step 904 may be repeated multiple times (for example, one for a different eTMF).

In a Step 905, the iTMF 940 may use the information contained in Step 903 (for example, WTRU ID, user IDs, user credentials, and so forth) to authenticate and authorize the “WTRU trust registration request.” The iTMF 940 may reject the WTRU trust registration request. Possible reasons for rejection could be as follows.

The iTMF 940 may consult with an NWDAF to retrieve the recent behavior of the WTRU 920, and the NWDAF indicates some abnormal behaviors of the WTRU 920 to the iTMF 940. Additionally or alternatively, the iTMF 940 may have been configured with some policies for rejecting the WTRU trust registration. One policy example includes when the WTRU 920 is in a specific location or region, then reject its WTRU trust registration.

The iTMF 940 creates the WTRU profile (e.g., UEProfile) and associates it with corresponding eTMF profiles, which have been created as a result of procedure in FIG. 8. A UEProfile may include one or any combination of the following. A UEID may be the same as received in step 901. An ExternalIDMapping is a mapping pair between ExternalTMFID and UEExternalID, which can be expressed in the format {ExternalTMFID: UEExternalID}. This mapping allows the iTMF 940 to identify the relevant eTMF profile when a TIDX request for the WTRU 920 reaches the iTMF 940 and triggers an external trust information request. By referencing this mapping, the iTMF 940 can efficiently locate and engage the appropriate an eTMF to obtain trust information about the WTRU 920. A UEContext may be the same as the UEContext in Step 901. A DefaultTMF may be the same as DefaultTMF in Step 901. A TrustedEDLst is a list of TMFs in EDLst, trusted by the iTMF 940, which may be utilized for future TIDX generation for the WTRU 920. In an example, the trust collaboration may have been established between the iTMF 940 and some eTMFs contained in EDLst, using the procedure in FIG. 8. Those eTMFs may be regarded as trusted by the iTMF 940.

In a Step 906, the iTMF 940 responds to the AMF 982 regarding the status of the WTRU trust registration, which could be: successful or failed. If successful, the iTMF 940 approves the WTRU trust registration request and stores the WTRU's profile for future reference. If failed, the iTMF 940 rejects the WTRU trust registration request. Possible reasons for rejection could be as follows. The iTMF 940 may consult with the NWDAF to retrieve the recent behavior of the WTRU 920 and the NWDAF indicates some abnormal behaviors of the WTRU 920 to the iTMF 940. Additionally or alternatively, the iTMF 940 may have been configured with some policies for rejecting the WTRU's entity trust registration. One policy example: When the WTRU is in a specific location or region, reject its entity trust registration.

In a Step 907, the AMF 982 sends a WTRU registration response to the WTRU 920, indicating its registration status. The response can have one of three possible states, as follows. One state is successful WTRU registration and successful WTRU trust registration. Another state is successful WTRU registration but failed WTRU trust registration. A further state is failed WTRU registration (and WTRU trust registration was not performed). WTRU trust registration is considered an advanced service and cannot succeed without WTRU registration being successful.

In a Step 908, the WTRU 920 may send a WTRU trust registration completion notification to the corresponding eTMF which manages the WTRU's trust information in an external domain. This notification may contain the following parameters: UEID, UEExternal ID, UEContext, and iTMFID. The iTMFID is the identifier of the iTMF 940. This parameter may also indicate application programming interface (API) information and/or contact information of the iTMF 940 or another NF in the internal domain through which the eTMF can reach the iTMF 940.

A Step 909 may be similar to Step 405 of FIG. 4. In Step 909, the WTRU 920 starts to interact with the NFP 950 (for example, an SMF) in the internal domain, directly over SBI or indirectly via the AMF 982.

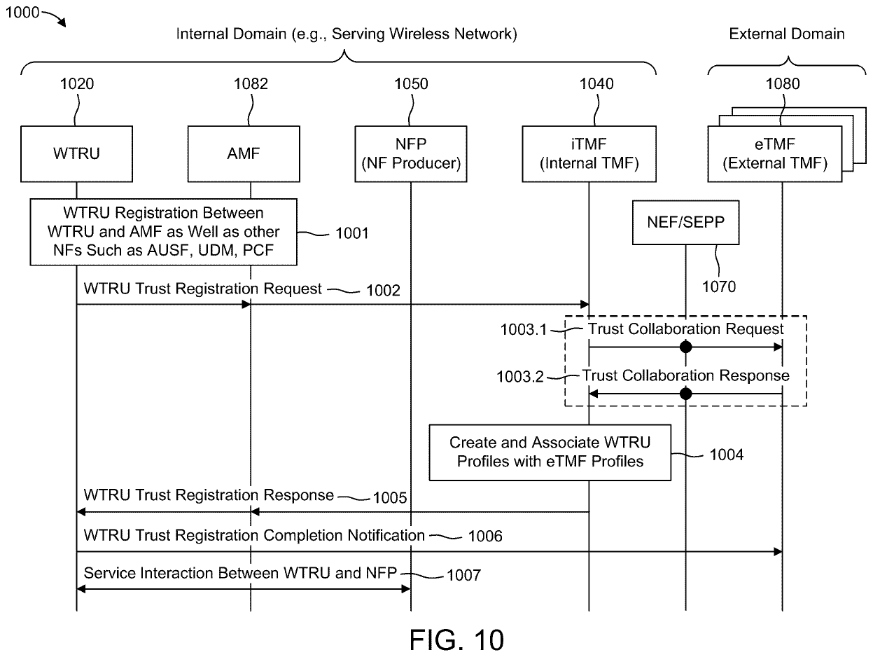

FIG. 10 is a signaling diagram illustrating an example of WTRU registration followed by WTRU trust registration. Signaling diagram 1000 illustrates a WTRU trust registration procedure triggered by WTRU registration. The iTMF may also leverage the procedure in FIG. 8 to establish trust collaboration with eTMFs.

FIG. 10 includes the following logic entities or actors. A WTRU 1020 is a mobile device and/or a user which requests to access services provided by an NFP 1050. The NFP 1050 is an NF producer which provides services to the WTRU 1020. The NFP 1050 may reside in a part of the serving wireless network (for example, base station, 6G edge network, 6G core network, or a 6G device/WTRU). The NFP 1050 could be an AMF. An iTMF 1040 is the TMF in the serving wireless network of WTRU, such as 6GS. One or more eTMF 1080 are the TMFs in a non-serving wireless network, which could be a DN and/or the home wireless network of WTRU. An AMF 1082 is an access and mobility management function in the serving network of WTRU 1020. Note that the AMF in 6GS may have a different name or embedded in a new 6G NF. In 6GS, a WTRU may be able to interact with an NF (for example, NFP and iTMF) directly over SBI without using an AMF. An NEF is a network exposure function in the serving wireless network of WTRU. In example, the NEF serves as a bridge for WN-with-AF communication. Note that NEF in 6GS may have a different name or embedded in a new 6G NF. An SEPP is a security edge protection proxy connecting the serving wireless network and the home wireless network. The SEPP handles WN-with-WN communication. Note that SEPP in 6GS may have a different name or embedded in a new 6G NF. An NEF/SEPP 1070 is in the cross-domain concept, where both scenarios are accounted for, and NEF and SEPP are collectively referred to as NEF/SEPP 1070.

In a Step 1001, an existing WTRU registration (for example, WTRU/UE registration in 5GS) is performed between the WTRU 1020 and NFs (for example, AMF, AUSF, UDM, PCF, and so forth). During this step, the AMF 1082 or other NFs such as a PCF may select or determine an iTMF for the WTRU 1020. Additionally or alternatively, a preselected or preconfigured iTMF for the WTRU 1020 may have been stored in the WTRU subscription data or associated with WTRU policies. When the AMF 1082 sends a WTRU Registration Accept to the WTRU 1020, the AMF 1082 may contain the identifier or contact information of the iTMF 1040 in the Registration Accept message, which indicates that the WTRU 1020 can start to perform WTRU trust registration with the iTMF 1040 immediately, or when certain trust registration conditions are satisfied.

In a Step 1002, the WTRU 1020 receives trust registration conditions from the network (for example, from the AMF 1082 in the Registration Accept message in step 1001). When the condition(s) are satisfied, the WTRU 1020 sends a WTRU trust registration request to the iTMF 1040. This message may be relayed by the AMF 1082 or be directly sent to the iTMF 1040 (for example, via SBI). Those trust registration conditions may be determined by the AMF 1082 or other NFs such as a PCF and be contained in the Registration Accept message. Examples of trust registration conditions may include a time delay, a particular location or region, other contextual information about the WTRU 1020, contextual information about the services that the WTRU 1020 may request to access, and so forth. This request is similar to Step 903 of FIG. 9.

A Step 1003 may be similar to Step 904 of FIG. 9, and may likewise include Sub-steps 1003.1 and 1003.2. Step 1003 may be repeated multiple times (for example, one for a different eTMF).

A Step 1004 may be similar to Step 905 of FIG. 9. A Step 1005 may be similar to Step 906 of FIG. 9. A Step 1006 may be similar to Step 908 of FIG. 9. Moreover, a Step 1007 may be similar to Step 909 of FIG. 9.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a function entity (FE), the method comprising:
receiving an FE trust registration request notification from a first network node, wherein the FE trust registration request notification includes contact information of the first network node;
sending an FE trust registration request to the first network node, wherein the FE trust registration request includes contact information of one or more external trust management functions (eTMFs), and includes an identifier of the FE;
receiving an FE trust registration response from the first network node, wherein the FE trust registration response includes one or more of: an identifier of an FE profile for the FE, an identifier of the one or more eTMFs, an identifier of one or more eTMF profiles, an association of the FE profile and the one or more eTMF profiles, or an identifier of the first network node; and
sending an FE trust registration completion notification to a selected eTMF of the one or more eTMFs, based on the FE trust registration response, wherein the FE trust registration completion notification includes the identifier of the first network node, an identifier of the selected eTMF, and the identifier of the FE.

2. The method of claim 1, wherein an internal Trust Management Function (iTMF) is in the first network node; wherein the iTMF operates within a current public land mobile network (PLMN) for the WTRU; and wherein the one or more eTMFs operate outside of the current PLMN for the WTRU.

3. The method of claim 1, wherein the FE trust registration request further includes an identifier for each of the one or more eTMFs.

4. The method of claim 1, wherein the identifier of the FE is an internal identifier.

5. The method of claim 1, wherein the identifier of the FE is an external identifier.

6. The method of claim 1, wherein the FE profile for the FE is a profile created by the first network node for the FE.

7. The method of claim 1, wherein the one or more eTMFs have trust collaboration relationships with the first network node.

8. The method of claim 1, wherein the one or more eTMF profiles are profiles of trusted eTMFs created by the first network node.

9. The method of claim 1, wherein the FE is a wireless transmit/receive unit (WTRU).

10. The method of claim 1, wherein the selected eTMF is in a second network node.

11. A function entity (FE) comprising:
a transceiver; and
a processor, operatively coupled to the transceiver; wherein:
the transceiver is configured to receive an FE trust registration request notification from a first network node, wherein the FE trust registration request notification includes contact information of the first network node;
the transceiver and the processor are configured to send an FE trust registration request to the first network node, wherein the FE trust registration request includes contact information of one or more external trust management functions (eTMFs), and includes an identifier of the FE;
the transceiver is configured to receive an FE trust registration response from the first network node, wherein the FE trust registration response includes one or more of: an identifier of an FE profile for the FE, an identifier of the one or more eTMFs, an identifier of one or more eTMF profiles, an association of the FE profile and the one or more eTMF profiles, or an identifier of the first network node; and
the transceiver and the processor are configured to send an FE trust registration completion notification to a selected eTMF of the one or more eTMFs, based on the FE trust registration response, wherein the FE trust registration completion notification includes the identifier of the first network node, an identifier of the selected eTMF, and the identifier of the FE.

12. The FE of claim 11, wherein an internal Trust Management Function (iTMF) is in the first network node; wherein the iTMF operates within a current public land mobile network (PLMN) for the WTRU; and wherein the one or more eTMFs operate outside of the current PLMN for the WTRU.

13. The FE of claim 11, wherein the FE trust registration request further includes an identifier for each of the one or more eTMFs.

14. The FE of claim 11, wherein the identifier of the FE is an internal identifier.

15. The FE of claim 11, wherein the identifier of the FE is an external identifier.

16. The FE of claim 11, wherein the FE profile for the FE is a profile created by the first network node for the FE.

17. The FE of claim 11, wherein the one or more eTMFs have trust collaboration relationships with the first network node.

18. The FE of claim 11, wherein the one or more eTMF profiles are profiles of trusted eTMFs created by the first network node.

19. The FE of claim 11, wherein the FE is a wireless transmit/receive unit (WTRU).

20. The FE of claim 11, wherein the selected eTMF is in a second network node.
